(19) United States
(12) Patent Application Publication
(10) Pub. No.: US 2025/0271741 A1
(43) Pub. Date: Aug. 28, 2025

(54) LIGHT SOURCE DEVICE AND PROJECTOR

(71) Applicant: SEIKO EPSON CORPORATION, Tokyo (JP)

(72) Inventor: Tomohiro YOKOO, Matsumoto-shi (JP)

(21) Appl. No.: 19/062,534

(22) Filed: Feb. 25, 2025

(30) Foreign Application Priority Data
Feb. 26, 2024 (JP) 2024-026213

(51) Int. Cl. G03B 21/20; G03B 21/00

(52) U.S. Cl. CPC G03B 21/204; G03B 21/008; G03B 21/2066; G03B 21/208

(57) ABSTRACT

A light source device of the present disclosure includes a first light source emitting a first light, a first wavelength conversion element converting the first light into a second light, a first optical layer transmitting the first light and reflecting the second light, a first light guide portion guiding the second light, a second light source e emitting a third light, a second wavelength conversion element converting the third light into a fourth light, a second optical layer transmitting the third light and reflecting the fourth light, a second light guide portion guiding the fourth light, and a first reflection member. The second wavelength conversion element is disposed at a side opposite to the first light source with respect to the first wavelength conversion element. The second light travels through the first light guide portion and is emitted from a region of the first light guide portion at a third surface side, and the fourth light travels through the second light guide portion and is emitted from a region of the second light guide portion at a sixth surface side.

The present application is based on, and claims priority from JP Application Serial Number 2024-026213, filed Feb. 26, 2024, the disclosure of which is hereby incorporated by reference herein in its entirety.

### BACKGROUND

### 1. Technical Field

The present disclosure relates to a light source device and a projector.

### 2. Related Art

As a light source device used in a projector, there has been proposed a light source device using fluorescence emitted from a phosphor when the phosphor is irradiated with excitation light emitted from a light emitting element. WO 2006/054203 discloses a light source device including a wavelength conversion member that has a flat plate shape and contains a phosphor, and a light emitting diode that emits excitation light. In this light source device, of a plurality of surfaces of the wavelength conversion member, the excitation light is entered from an incident surface having a larger area and fluorescence is emitted from an emission surface having a smaller area.

WO 2006/054203 is an example of the related art.

In the light source device of WO 2006/054203, the fluorescence generated inside the wavelength conversion member is totally reflected at an interface between the surface of the wavelength conversion member and an air layer to thereby propagate inside the wavelength conversion member, and is then emitted from the emission surface. However, a component of the fluorescence that enters the interface between the wavelength conversion member and the air layer at an angle smaller than the critical angle is not totally reflected at the interface, and thus leaks to the outside from the interface before reaching the emission surface. Accordingly, there is a problem that the use efficiency of the fluorescence becomes lower.

### SUMMARY

A light source device according to an aspect of the present disclosure includes a first light source emitting a first light in a first wavelength range, a first wavelength conversion element converting the first light into a second light in a second wavelength range different from the first wavelength range, a first optical layer disposed between the first light source and the first wavelength conversion element and transmitting the first light and reflecting the second light, a first light guide portion disposed between the first optical layer and the first wavelength conversion element and guiding the second light converted by the first wavelength conversion element, a second light source emitting a third light in a third wavelength range, a second wavelength conversion element converting the third light into a fourth light in a fourth wavelength range different from the third wavelength range or the second wavelength range, a second optical layer disposed between the second light source and the second wavelength conversion element and transmitting the third light and reflecting the fourth light, a second light guide portion disposed between the second optical layer and the second wavelength conversion element and guiding the fourth light converted by the second wavelength conversion element, and a first reflection member reflecting the first light, the second light, the third light, and the fourth light. The first wavelength conversion element includes a first surface entered by the first light via the first optical layer and the first light guide portion, and a second surface and a third surface crossing the first surface and facing opposite sides to each other. The second wavelength conversion element includes a fourth surface entered by the third light via the second optical layer and the second light guide portion, and a fifth surface and a sixth surface crossing the fourth surface and facing opposite sides to each other. The first reflection member is disposed in a region at the second surface side of the first light guide portion and a region at the fifth surface side of the second light guide portion. The second wavelength conversion element is disposed at a side opposite to the first light source with respect to the first wavelength conversion element. The second light converted by the first wavelength conversion element travels through the first light guide portion and is emitted from a region of the first light guide portion at the third surface side, and the fourth light converted by the second wavelength conversion element travels through the second light guide portion and is emitted from a region of the second light guide portion at the sixth surface side.

A light source device according another aspect of the present disclosure includes a first light source emitting a first light in a first wavelength range, a first wavelength conversion element converting the first light into a second light in a second wavelength range different from the first wavelength range, a first optical layer disposed between the first light source and the first wavelength conversion element and transmitting the first light and reflecting the second light, a second light source emitting a third light in a third wavelength range, a second wavelength conversion element converting the third light into a fourth light in a fourth wavelength range different from the third wavelength range or the second wavelength range, a second optical layer disposed between the second light source and the second wavelength conversion element and transmitting the third light and reflecting the fourth light, a light guide portion disposed between the first wavelength conversion element and the second wavelength conversion element, and guiding the second light converted by the first wavelength conversion element and guiding the fourth light converted by the second wavelength conversion element, and a first reflection member reflecting the first light, the second light, the third light, and the fourth light. The first wavelength conversion element includes a first surface entered by the first light via the first optical layer and the first light guide portion, and a second surface and a third surface crossing the first surface and facing opposite sides to each other. The second wavelength conversion element includes a fourth surface entered by the third light via the second optical layer and the second light guide portion, and a fifth surface and a sixth surface crossing the fourth surface and facing opposite sides to each other. The second wavelength conversion element is disposed at a side opposite to the first light source with respect to the first wavelength conversion element. The first reflection member is disposed in a region at the second surface side of the light guide portion. The second light converted by the first wavelength conversion element and the fourth light converted by the second wavelength conversion element travel through the light guide portion and are emitted from a region of the light guide portion at the third surface side.

A projector according to an aspect of the present disclosure includes the light source device according to the aspect of the present disclosure, a light modulation device modulating a light emitted from the light source device, and a projection optical device projecting the light modulated by the light modulation device.

### BRIEF DESCRIPTION OF THE DRAWINGS

FIG. 1 is a schematic configuration diagram of a projector according to a first embodiment.

FIG. 2 is a perspective view of a light source device according to the first embodiment.

FIG. 3 is a cross-sectional view of the light source device cut along line III-III in FIG. 2.

FIG. 4 is a cross-sectional view of the light source device cut along line IV-IV in FIG. 3.

FIG. 5 is a cross-sectional view of a light source device according to a second embodiment.

FIG. 6 is a cross-sectional view of a light source device according to a third embodiment.

FIG. 7 is a cross-sectional view of a light source device according to a fourth embodiment.

FIG. 8 is a perspective view of a light source device according to a fifth embodiment.

FIG. 9 is a cross-sectional view of the light source device cut along line IX-IX in FIG. 8.

FIG. 10 is a schematic diagram showing functions of the light source device of the fifth embodiment.

FIG. 11 is a cross-sectional view of a light source device according to a sixth embodiment.

FIG. 12 is a cross-sectional view of a light source device according to a seventh embodiment.

FIG. 13 is a cross-sectional view of a light source device according to an eighth embodiment.

### DESCRIPTION OF EMBODIMENTS

### First Embodiment

As below, a first embodiment of the present disclosure will be described using the drawings.

A projector according to the embodiment is an example of a projector using liquid crystal panels as light modulation devices.

In the following drawings, some component elements may be shown at different dimensional scales for clarity of the respective component elements.

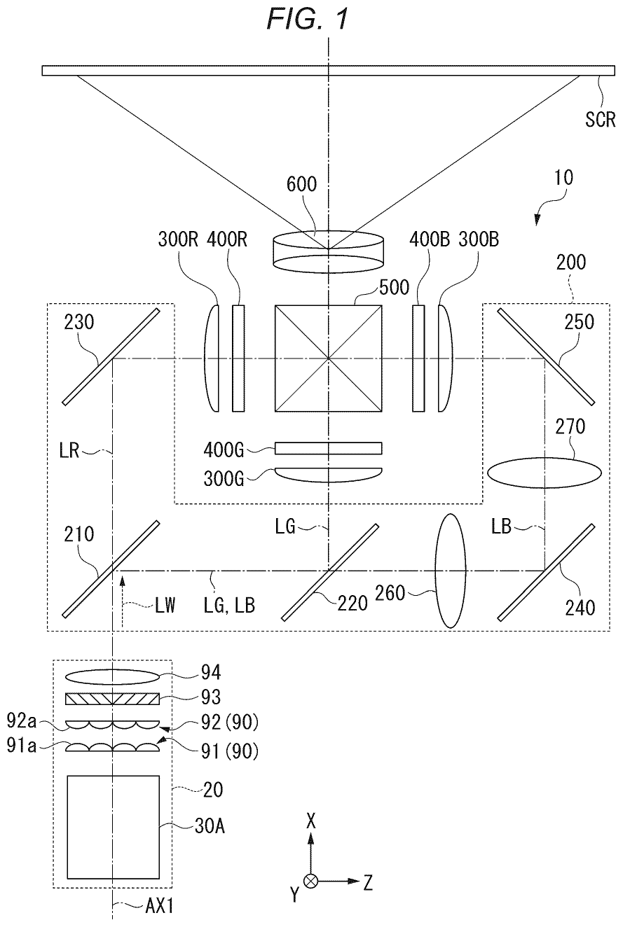

FIG. 1 is a schematic configuration diagram of a projector 10 of the embodiment.

As shown in FIG. 1, the projector 10 of the embodiment is a projection-type image display apparatus that displays a color image on a screen SCR as a projection surface. The projector 10 includes three light modulation devices respectively corresponding to color lights of a red light LR, a green light LG, and a blue light LB.

The projector 10 includes an illumination device 20, a color separation/light guide system 200, a red light modulation device 400R, a green light modulation device 400G, a blue light modulation device 400B, a light combining element 500, and a projection optical device 600.

The illumination device 20 includes a light source device 30A, an optical integration system 90, a polarization conversion element 93, and a superimposing system 94. The illumination device 20 emits a white light LW containing the red light LR, the green light LG, and the blue light LB. A specific configuration of the illumination device 20 will be described later.

The description with reference to the drawings will hereinafter be made using an X-Y-Z orthogonal coordinate system as necessary. An X-axis is an axis parallel to an optical axis AX1 of the illumination device 20 and along the front-back direction of the projector 10. A Y-axis is an axis orthogonal to the X-axis and along the vertical direction of the projector 10. A Z-axis is an axis orthogonal to the X-axis and the Y-axis, and along the left-right direction of the projector 10. The coordinate system is for description of the arrangement relationship among the component members of the projector 10, and does not limit an attitude and a direction of installation of the projector 10. The optical axis AX1 of the illumination device 20 is the center axis of the white light LW emitted from the illumination device 20.

In the following description, one of the two directions along the X-axis is referred to as “+X direction”, and the opposite direction is referred to as “−X direction”. One of the two directions along the Y-axis is referred to as “+Y direction”, and the opposite direction is referred to as “−Y direction”. One of the two directions along the Z-axis is referred to as “+Z direction”, and the opposite direction is referred to as “−Z direction”. The two directions along the X-axis may be collectively referred to as “X-axis direction” without distinction. The two directions along the Y-axis may be collectively referred to as “Y-axis direction” without distinction. The two directions along the Z-axis may be collectively referred to as “Z-axis direction” without distinction.

The color separation/light guide system 200 includes a first dichroic mirror 210, a second dichroic mirror 220, a first reflection mirror 230, a second reflection mirror 240, a third reflection mirror 250, a first relay lens 260, and a second relay lens 270. The color separation/light guide system 200 separates the white light LW emitted from the illumination device 20 into the red light LR, the green light LG, and the blue light LB, guides the red light LR to the red light modulation device 400R, guides the green light LG to the green light modulation device 400G, and guides the blue light LB to the blue light modulation device 400B.

A field lens 300R is disposed between the color separation/light guide system 200 and the red light modulation device 400R. A field lens 300G is disposed between the color separation/light guide system 200 and the green light modulation device 400G. A field lens 300B is disposed between the color separation/light guide system 200 and the blue light modulation device 400B. The field lens 300R parallelizes the principal ray of the red light LR to enter the light modulation device 400R. The field lens 300G parallelizes the principal ray of the green light LG to enter the light modulation device 400G. The field lens 300B parallelizes the principal ray of the blue light LB to enter the light modulation device 400B.

The first dichroic mirror 210 transmits the red light LR and reflects the green light LG and the blue light LB. The second dichroic mirror 220 reflects the green light LG and transmits the blue light LB. The first reflection mirror 230 reflects the red light LR. Each of the second reflection mirror 240 and the third reflection mirror 250 reflects the blue light LB.

Each of the red light modulation device 400R, the green light modulation device 400G, and the blue light modulation device 400B modulates the color light entered into each light modulation device according to image information to generate an image light. Each of the red light modulation device 400R, the green light modulation device 400G, and the blue light modulation device 400B includes a liquid crystal panel.

Though not illustrated, light incident-side polarizers are respectively disposed between the field lens 300R and the red light modulation device 400R, between the field lens 300G and the green light modulation device 400G, and between the field lens 300B and the blue light modulation device 400B. Further, light exiting-side polarizers are respectively disposed between the red light modulation device 400R and the light combining element 500, between the green light modulation device 400G and the light combining element 500, and between the blue light modulation device 400B and the light combining element 500. The light incident-side polarizer and the light exiting-side polarizer allow only a linearly-polarized light in a particular direction to pass through.

The light combining element 500 is incident by the image lights emitted from the light modulation device 400R, the light modulation device 400G, and the light modulation device 400B, combines the image lights corresponding to the red light LR, the green light LG, and the blue light LB, and outputs the combined image light toward the projection optical device 600. As the light combining element 500, for example, a cross dichroic prism is used.

The projection optical device 600 includes a plurality of projection lenses. The projection optical device 600 enlarges and projects the image light combined by the light combining element 500 toward the screen SCR. Thereby, an image is displayed on the screen SCR.

As below, configurations of the light source device 30A and the illumination device 20 will be described.

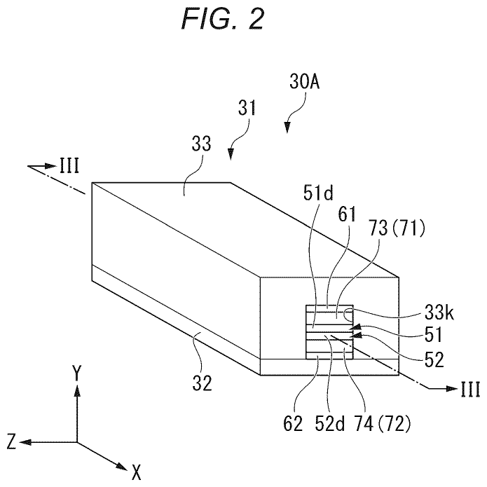

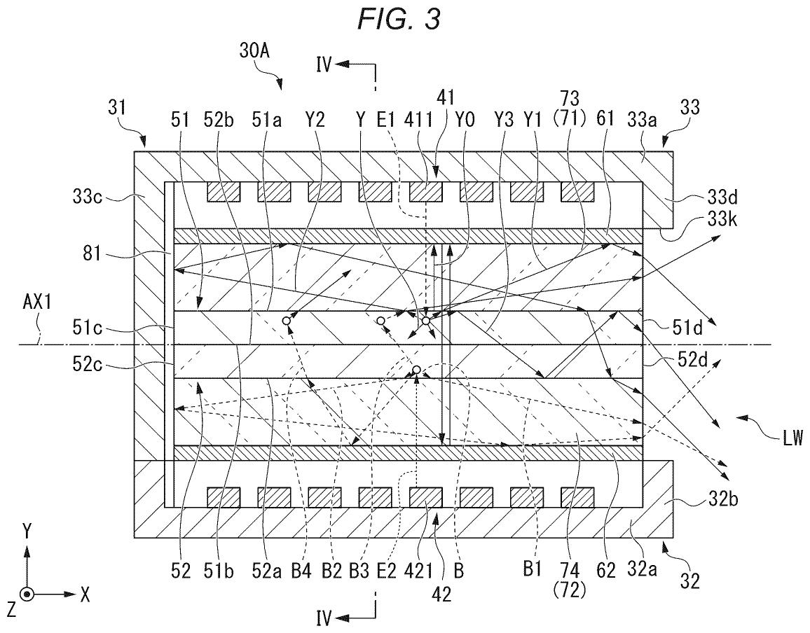

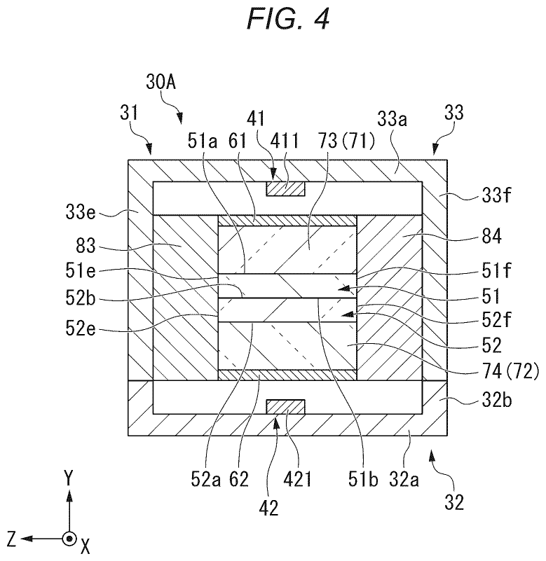

FIG. 2 is a perspective view of the light source device 30A of the embodiment. FIG. 3 is a cross-sectional view of the light source device 30A cut along line III-III in FIG. 2. FIG. 4 is a cross-sectional view of the light source device 30A cut along line IV-IV in FIG. 3.

As shown in FIGS. 2 to 4, the light source device 30A of the embodiment includes a housing 31, a first light source 41, a first wavelength conversion element 51, a first optical layer 61, a first light guide portion 71, a second light source 42, a second wavelength conversion element 52, a second optical layer 62, a second light guide portion 72, a first reflection member 81, a third reflection member 83, and a fourth reflection member 84.

The housing 31 forms an exterior of the light source device 30A. The housing 31 houses the first light source 41, the first optical layer 61, the first light guide portion 71, the first wavelength conversion element 51, the second light source 42, the second optical layer 62, the second light guide portion 72, the second wavelength conversion element 52, the first reflection member 81, the third reflection member 83, and the fourth reflection member 84. The housing 31 includes a bottom plate 32 and a lid 33. The bottom plate 32 has substantially a plate shape. The lid 33 has a box shape with one face opened, and includes a top wall portion 33a, a first side wall portion 33c, a second side wall portion 33d, a third side wall portion 33e, a fourth side wall portion 33f, and an extraction opening 33k.

The bottom plate 32 is disposed along the XZ-plane and supports the second light source 42. The bottom plate 32 includes a base portion 32a and a frame portion 32b. The base portion 32a is a plate-like member forming the main body of the bottom plate 32 and extends to be longer in the X-axis direction. The frame portion 32b is formed integrally with the base portion 32a, and is provided on a surface located at the +Y side of the base portion 32a. The bottom plate 32 has a recessed portion for holding the second light source 42.

The bottom plate 32 is coupled to transfer heat to the second light source 42. Accordingly, the bottom plate 32 is desirably formed using a material having a predetermined strength and higher thermal conductivity. As the material of the bottom plate 32, it is desirable to use, for example, a metal such as aluminum or stainless steel, and particularly, 6061 aluminum alloy.

In the lid 33, the top wall portion 33a is disposed along the XZ-plane. The first side wall portion 33c and the second side wall portion 33d cross the X-axis along the longitudinal direction of the light source device 30A and are located at opposite sides to each other in the X-axis direction. The first side wall portion 33c is located at the −X side as one side in the X-axis direction. The second side wall portion 33d is located at the +X side as the other side in the X-axis direction. The third side wall portion 33e and the fourth side wall portion 33f are located at opposite sides to each other in the Z-axis direction crossing the longitudinal direction of the light source device 30A. In the embodiment, the third side wall portion 33e is located at the +Z side as one side in the Z-axis direction. The fourth side wall portion 33f is located at the −Z side as the other side in the Z-axis direction.

The lid 33 holds the first light source 41, the first optical layer 61, the first light guide portion 71, the first wavelength conversion element 51, the second optical layer 62, the second light guide portion 72, the second wavelength conversion element 52, the first reflection member 81, the third reflection member 83, and the fourth reflection member 84. The top wall portion 33a is coupled to transfer heat to the first light source 41. The third side wall portion 33e and the fourth side wall portion 33f are coupled to transfer heat to the first wavelength conversion element 51 and the second wavelength conversion element 52 via the third reflection member 83 and the fourth reflection member 84. Accordingly, like the bottom plate 32, the lid 33 is desirably formed using a material having a predetermined strength and higher thermal conductivity. As the material of the lid 33, like the bottom plate, it is desirable to use, for example, a metal such as aluminum or stainless steel, and particularly, 6061 aluminum alloy.

According to the configuration, since the heat of the first wavelength conversion element 51 and the second wavelength conversion element 52 is released to the outside through the lid 33, the temperature rise of the first wavelength conversion element 51 and the second wavelength conversion element 52 can be suppressed. As a result, a decrease in wavelength conversion efficiency due to the temperature rise of the first wavelength conversion element 51 and the second wavelength conversion element 52 can be suppressed.

As shown in FIG. 3, the first reflection member 81 is disposed on the first side wall portion 33c of the lid 33. As shown in FIG. 4, the third reflection member 83 is disposed on the third side wall portion 33e of the lid 33. The fourth reflection member 84 is disposed on the fourth side wall portion 33f of the lid 33. The extraction opening 33k is provided in the second side wall portion 33d of the lid 33. The extraction opening 33k is an opening for extracting yellow fluorescence Y emitted from the first light guide portion 71 and the first wavelength conversion element 51 and blue fluorescence B emitted from the second light guide portion 72 and the second wavelength conversion element 52 to the outside.

The lid 33 is placed in contact with the base portion 32a of the bottom plate 32. The lid 33 and the bottom plate 32 are fixed to each other via a fixing member such as an adhesive or a screw (not shown). As described above, in the light source device 30A, the respective component elements of the first light source 41, the first optical layer 61, the first light guide portion 71, the first wavelength conversion element 51, the second light source 42, the second optical layer 62, the second light guide portion 72, the second wavelength conversion element 52, the first reflection member 81, the third reflection member 83, and the fourth reflection member 84 are held in a space surrounded by the housing 31. Thereby, adhesion of foreign matter such as dust to the above described component elements can be suppressed.

The first light source 41 includes a plurality of first light emitting elements 411. The plurality of first light emitting elements 411 are respectively mounted on the top wall portion 33a of the housing 31. The number of the first light emitting elements 411 provided in the first light source is not particularly limited. The first light emitting element 411 emits a first excitation beam in a first wavelength range. The first light emitting element 411 includes, for example, a light emitting diode (LED). The first light emitting element 411 is disposed to face the first wavelength conversion element 51, and emits the first excitation beam toward the first wavelength conversion element 51. The first wavelength range is, for example, a violet-to-blue wavelength range from 400 nm to 480 nm and has a center wavelength of, for example, 455 nm. The plurality of first light emitting elements 411 are arranged along the X-axis direction as the longitudinal direction of the first wavelength conversion element 51. As described above, the first light source 41 emits a first excitation light E1 in the first wavelength range including a plurality of blue first excitation beams toward the first wavelength conversion element 51. The first excitation light E1 in the embodiment corresponds to a first light in Claims.

The first wavelength conversion element 51 has a columnar shape extending along the X-axis and has six surfaces. The sides of the first wavelength conversion element 51 extending along the X-axis are longer than the sides extending along the Y-axis and the sides extending along the Z-axis. The X-axis direction corresponds to the longitudinal direction of the first wavelength conversion element 51. The Y-axis direction is a direction parallel to the shortest side of the sides of the first wavelength conversion element 51. The lengths of the sides along the Y-axis are shorter than the lengths of the sides along the Z-axis. That is, the cross-sectional shape of the first wavelength conversion element 51 cut along a plane along the YZ-plane is a rectangular shape as shown in FIG. 4.

The first wavelength conversion element 51 includes a front surface 51a and a back surface 51b, a first end surface 51c and a second end surface 51d, and a first side surface 51e and a second side surface 51f. The front surface 51a and the back surface 51b cross the Y-axis and face opposite sides to each other in the Y-axis. In the embodiment, the front surface 51a is a surface located at the +Y side as one side in the Y-axis direction. The back surface 51b is a surface located at the −Y side as the other side in the Y-axis direction. The first excitation light E1 enters the front surface 51a from the first light source 41 disposed on the top wall portion 33a via the first optical layer 61 and the first light guide portion 71. The front surface 51a of the embodiment corresponds to a first surface in Claims.

As shown in FIG. 3, the first end surface 51c and the second end surface 51d cross the front surface 51a and the back surface 51b, and face opposite sides to each other in the X-axis direction along the longitudinal direction of the first wavelength conversion element 51. In the embodiment, the first end surface 51c is located at the −X side as one side in the X-axis direction. The second end surface 51d is located at the +X side as the other side in the X-axis direction. The first end surface 51c of the embodiment corresponds to a second surface in Claims. The second end surface 51d of the embodiment corresponds to a third surface in Claims.

As shown in FIG. 4, the first side surface 51e and the second side surface 51f cross the front surface 51a and the back surface 51b and the first end surface 51c and the second end surface 51d, and face opposite sides to each other in the Z-axis direction. In the embodiment, the first side surface 51e is located at the +Z side as one side in the Z-axis direction, and the second side surface 51f is located at the −Z side as the other side in the Z-axis direction. The first side surface 51e of the embodiment corresponds to a seventh surface in Claims. The second side surface 51f of the embodiment corresponds to an eighth surface in Claims.

The first wavelength conversion element 51 contains at least yellow phosphor, and converts the first excitation light E1 in the first wavelength range emitted from the first light source 41 into yellow fluorescence Y in a second wavelength range different from the first wavelength range. As will be described in detail later, part of the yellow fluorescence Y generated inside the first wavelength conversion element 51 is emitted from the front surface 51a to the first light guide portion 71.

The first wavelength conversion element 51 contains ceramic phosphor including polycrystalline phosphor for wavelength-conversion of the first excitation light E1 into yellow fluorescence Y. The first wavelength conversion element 51 of the embodiment is formed using phosphor without a light scattering property, the so-called transparent phosphor. The second wavelength range of the yellow fluorescence Y is a yellow wavelength range, for example, from 490 to 750 nm. The center wavelength of the second wavelength range is, for example, 550 nm. That is, the fluorescence Y is yellow fluorescence containing a red light component and a green light component. The yellow fluorescence Y of the embodiment corresponds to a second light in Claims.

The first wavelength conversion element 51 may include single crystal phosphor instead of the polycrystalline phosphor. Or, the first wavelength conversion element 51 may include fluorescent glass. Or, the first wavelength conversion element 51 may be formed using a material obtained by dispersion of a large number of phosphor particles in a binder of glass or resin. The first wavelength conversion element 51 formed using the material converts the first excitation light E1 into yellow fluorescence Y.

Specifically, the material of the first wavelength conversion element 51 includes, for example, yttrium aluminum garnet (YAG)-based phosphor. YAG:Ce containing cerium (Ce) as an activator is taken as an example. As the material of the first wavelength conversion element 51, a material obtained by mixing and solid-phase reaction of raw powder containing constituent elements such as Y₂O₃, Al₂O₃, CeO₃, Y—Al—O amorphous particles obtained by a wet process such as a coprecipitation process or a sol-gel process, YAG particles obtained by a gas-phase process such as a spray-drying process, a flame pyrolysis process, or a thermal plasma process, or the like is used.

The first optical layer 61 is disposed between the first light source 41 and the first wavelength conversion element 51. The first optical layer 61 has an optical property of transmitting the first excitation light E1 and reflecting yellow fluorescence Y. The first optical layer 61 includes, for example, a dielectric multilayer film. The first optical layer 61 is disposed on a surface of the first light-transmissive member 73, which will be described later, facing the first light source 41.

The first light guide portion 71 is disposed between the first optical layer 61 and the first wavelength conversion element 51. The first light guide portion 71 guides the yellow fluorescence Y converted by the first wavelength conversion element 51. In the embodiment, the first light-transmissive member 73 that transmits the first excitation light E1 and the yellow fluorescence Y is disposed in the first light guide portion 71. The first light-transmissive member 73 is bonded to the front surface 51a of the first wavelength conversion element 51 by an optical adhesive.

The first light-transmissive member 73 is formed using a light-transmissive material including, for example, borosilicate glass such as BK7, quartz, synthetic quartz, quartz crystal, SiC, GaN, MgO, YAG, sapphire, and diamond. As described above, it is necessary to form the first light-transmissive member 73 using a material that can transmit the first excitation light E1 and the yellow fluorescence Y. The first light-transmissive member 73 has a plate shape extending along the X-axis. As shown in FIG. 4, the cross-sectional shape of the first light-transmissive member 73 cut along a plane along the YZ-plane is a rectangular shape extending to be longer in the X-axis direction.

It is desirable that the thermal conductivity of the first light-transmissive member 73 is higher than the thermal conductivity of the first wavelength conversion element 51. The material of the first light-transmissive member 73 that satisfies the relationship includes, for example, SiC, GaN, YAG, MgO, sapphire, and diamond. According to the configuration, since the heat of the first wavelength conversion element 51 is efficiently transferred to the first light-transmissive member 73, the temperature rise of the first wavelength conversion element 51 can be suppressed. Thereby, a decrease in conversion efficiency due to the temperature rise of the first wavelength conversion element 51 can be suppressed.

As shown in FIG. 3, the second light source 42 includes a plurality of second light emitting elements 421. The plurality of second light emitting elements 421 are respectively mounted on the bottom plate 32 of the housing 31. Note that the number of the second light emitting elements 421 is not particularly limited. The second light emitting element 421 emits a second excitation beam in a third wavelength range. The second light emitting element 421 includes, for example, an LED. The second light emitting element 421 is disposed to face the second wavelength conversion element 52, and emits the second excitation beam toward the second wavelength conversion element 52. The third wavelength range is, for example, an ultraviolet wavelength range, and the center wavelength is, for example, 380 nm. The plurality of second light emitting elements 421 are arranged along the X-axis direction as the longitudinal direction of the second wavelength conversion element 52. As described above, the second light source 42 emits a second excitation light E2 in the third wavelength range including a plurality of ultraviolet second excitation beams toward the second wavelength conversion element 52. The second excitation light E2 of the embodiment corresponds to a third light in Claims.

The second wavelength conversion element 52 is disposed at the −Y side of the first wavelength conversion element 51. That is, the second wavelength conversion element 52 is disposed at the side opposite to the first light source 41 with respect to the first wavelength conversion element 51. In the embodiment, the back surface 51b of the first wavelength conversion element 51 and the back surface 52b of the second wavelength conversion element 52 are bonded to each other via a bonding material (not shown) such as an optical adhesive. According to the configuration, the first wavelength conversion element 51 and the second wavelength conversion element 52 can be handled as an integrated member, and thereby, the manufacturing process of the light source device can be made easier. Further, since the first wavelength conversion element 51 and the second wavelength conversion element 52 are arranged side by side in the direction (Y-axis direction) orthogonal to the longitudinal direction (X-axis direction) of the respective wavelength conversion elements 51 and 52, the length in the X-axis direction is not so long, and the small light source device 30A can be realized.

The second wavelength conversion element 52 has a columnar shape extending along the X-axis and has six surfaces. The sides of the second wavelength conversion element 52 extending along the X-axis are longer than the sides extending along the Y-axis and the sides extending along the Z-axis. The X-axis direction corresponds to the longitudinal direction of the second wavelength conversion element 52. The Y-axis direction is a direction parallel to the shortest side of the sides of the second wavelength conversion element 52. The lengths of the sides along the Y-axis are shorter than the lengths of the sides along the Z-axis. That is, the cross-sectional shape of the second wavelength conversion element 52 cut along a plane along the YZ-plane is a rectangular shape as shown in FIG. 4.

The second wavelength conversion element 52 has a front surface 52a and a back surface 52b, a first end surface 52c and a second end surface 52d, and a first side surface 52e and a second side surface 52f. The front surface 52a and the back surface 52b cross the Y-axis and face opposite sides to each other in the Y-axis. In the embodiment, the front surface 52a is a surface located at the −Y side as one side in the Y-axis direction. The back surface 52b is a surface located at the +Y side as the other side in the Y-axis direction. The second excitation light E2 enters the front surface 52a from the second light source 42 disposed on the bottom plate 32 via the second optical layer 62 and the second light guide portion 72. The front surface 52a of the embodiment corresponds to a fourth surface in Claims.

As shown in FIG. 3, the first end surface 52c and the second end surface 52d cross the front surface 52a and the back surface 52b, and face opposite sides to each other in the X-axis direction along the longitudinal direction of the second wavelength conversion element 52. In the embodiment, the first end surface 52c is located at the −X side as one side in the X-axis direction. The second end surface 52d is located at the +X side as the other side in the X-axis direction. The first end surface 52c of the embodiment corresponds to a fifth surface in Claims. The second end surface 52d of the embodiment corresponds to a sixth surface in Claims.

As shown in FIG. 4, the first side surface 52e and the second side surface 52f cross the front surface 52a and the back surface 52b and the first end surface 52c and the second end surface 52d, and face opposite sides to each other in the Z-axis direction. In the embodiment, the first side surface 52e is located at the +Z side as one side in the Z-axis direction, and the second side surface 52f is located at the −Z side as the other side in the Z-axis direction. The first side surface 52e of the embodiment corresponds to a ninth surface in Claims. The second side surface 52f of the embodiment corresponds to a tenth surface in Claims.

The second wavelength conversion element 52 contains at least blue phosphor, and converts the second excitation light E2 in the third wavelength range emitted from the plurality of second light emitting elements 421 of the second light source 42 into blue fluorescence B in a fourth wavelength range different from the third wavelength range or the second wavelength range. As will be described in detail later, part of the blue fluorescence B generated inside the second wavelength conversion element 52 is emitted from the front surface 52a to the second light guide portion 72.

The second wavelength conversion element 52 includes phosphor for wavelength-conversion of the second excitation light E2 into blue fluorescence B. The phosphor includes (Sr, Ba)₁₀(PO₄)₆Cl₂:Eu²⁺ (SBCA) as an example. The second wavelength conversion element 52 of the embodiment is formed using phosphor without a light scattering property, the so-called transparent phosphor. The fourth wavelength range of the blue fluorescence B is, for example, a blue wavelength range from 430 to 490 nm. The center wavelength of the fourth wavelength range is, for example, 460 nm. As the material of the second wavelength conversion element 52, BaMgAl₁₀O₁₇:Eu(II) or the like may be used. The blue fluorescence B of the embodiment corresponds to a fourth light in Claims.

The second optical layer 62 is disposed between the second light source 42 and the second wavelength conversion element 52. The second optical layer 62 has an optical property of transmitting the second excitation light E2 and reflecting the blue fluorescence B. The second optical layer 62 includes, for example, a dielectric multilayer film. The second optical layer 62 is disposed on a surface of a second light-transmissive member 74, which will be described later, facing the second light source 42. The second optical layer 62 reflects lights having wavelengths equal to or longer than those in the fourth wavelength range, and not only reflects the blue fluorescence B but also the yellow fluorescence Y generated in the first wavelength conversion element 51.

The second light guide portion 72 is disposed between the second optical layer 62 and the second wavelength conversion element 52. The second light guide portion 72 guides the blue fluorescence B converted by the second wavelength conversion element 52. In the embodiment, the second light-transmissive member 74 that transmits the second excitation light E2 and the blue fluorescence B is disposed in the second light guide portion 72. The second light-transmissive member 74 is bonded to the front surface 52a of the second wavelength conversion element 52 by an optical adhesive.

The second light-transmissive member 74 is formed using a light-transmissive material including, for example, borosilicate glass such as BK7, quartz, synthetic quartz, quartz crystal, SiC, GaN, MgO, YAG, sapphire, and diamond. As described above, it is necessary to form the second light-transmissive member 74 using a material that can transmit the second excitation light E2 and the blue fluorescence B. The second light-transmissive member 74 has a plate shape extending along the X-axis. As shown in FIG. 4, the cross-sectional shape of the second light-transmissive member 74 cut along a plane along the YZ-plane is a rectangular shape extending to be longer in the X-axis direction. The constituent material of the second light-transmissive member 74 may be the same as or different from the constituent material of the first light-transmissive member 73.

It is desirable that the thermal conductivity of the second light-transmissive member 74 is higher than the thermal conductivity of the second wavelength conversion element 52. The material of the second light-transmissive member 74 that satisfies the relationship includes SiC, GaN, MgO, YAG, sapphire, and diamond. According to the configuration, since the heat of the second wavelength element 52 is efficiently transferred to the second light-transmissive member 74, the temperature rise of the second wavelength conversion element 52 can be suppressed. Thereby, a decrease in conversion efficiency due to the temperature rise of the second wavelength conversion element 52 can be suppressed.

As shown in FIG. 3, the first reflection member 81 is disposed at the −X side of the first light source 41, the first optical layer 61, the first light guide portion 71, the first wavelength conversion element 51, the second wavelength conversion element 52, the second light guide portion 72, the second optical layer 62, and the second light source 42. The first reflection member 81 is disposed on the first side wall portion 33c of the housing 31. The first reflection member 81 is not necessarily provided all over the above described regions, but may be provided at least in the region at the first end surface 51c side of the first light guide portion 71 and the region at the first end surface 52c side of the second light guide portion 72.

The first reflection member 81 reflects the yellow fluorescence Y propagating inside the first light guide portion 71 and the first wavelength conversion element 51 and reaching the first reflection member 81 and the blue fluorescence B propagating inside the second light guide portion 72 and the second wavelength conversion element 52 and reaching the first reflection member 81. Further, the first reflection member 81 reflects the first excitation light E1 propagating through the first wavelength conversion element 51 or the first light guide portion 71 and reaching the first reflection member 81 and the second excitation light E2 propagating through the second wavelength conversion element 52 or the second light guide portion 72 and reaching the first reflection member 81. That is, the first reflection member 81 reflects the yellow fluorescence Y, the blue fluorescence B, the first excitation light E1, and the second excitation light E2. The first reflection member 81 includes, for example, a metal film, a dielectric multilayer film, and a scattering member containing barium sulfate.

As shown in FIG. 4, the third reflection member 83 is disposed on the third side wall portion 33e of the housing 31 to face the first side surface 51e of the first wavelength conversion element 51, the region of the first light guide portion 71 at the first side surface 5l side, the first side surface 52e of the second wavelength conversion element 52, and the region of the second light guide portion 72 at the first side surface 52e side. The fourth reflection member 84 is disposed on the fourth side wall portion 33f of the housing 31 to face the second side surface 51f of the first wavelength conversion element 51, the region of the first light guide portion 71 at the second side surface 51f side, the second side surface 52f of the second wavelength conversion element 52, and the region of the second light guide portion 72 at the second side surface 52f side.

The third reflection member 83 reflects the yellow fluorescence Y, the blue fluorescence B, the first excitation light E1, and the second excitation light E2. Accordingly, the third reflection member 83 reflects the first excitation light E1 reflected by the front surface 51a of the first wavelength conversion element 51, entering the first light guide portion 71, and reaching the third reflection member 83 and enters the light into the first wavelength conversion element 51. Thereby, the conversion efficiency from the first excitation light E1 to the yellow fluorescence Y can be increased. Further, the third reflection member 83 reflects the second excitation light E2 reflected by the front surface 52a of the second wavelength conversion element 52, entering the second light guide portion 72, and reaching the third reflection member 83 and enters the light into the second wavelength conversion element 52. Thereby, the conversion efficiency from the second excitation light E2 to the blue fluorescence B can be increased.

Furthermore, the third reflection member 83 reflects the yellow fluorescence Y emitted from the first wavelength conversion element 51, entering the first light guide portion 71, and reaching the third reflection member 83 and the yellow fluorescence Y guided inside the first wavelength conversion element 51 and reaching the third reflection member 83. Thereby, the loss of the yellow fluorescence Y can be suppressed. In addition, the third reflection member 83 reflects the blue fluorescence B emitted from the second wavelength conversion element 52, entering the second light guide portion 72, and reaching the third reflection member 83 and the blue fluorescence B guided inside the second wavelength conversion element 52 and reaching the third reflection member 83. Thereby, the loss of the blue fluorescence B can be suppressed.

Similarly, the fourth reflection member 84 reflects the yellow fluorescence Y, the blue fluorescence B, the first excitation light E1, and the second excitation light E2. The functions and effects of the fourth reflection member 84 are the same as those of the above described third reflection member 83. The third reflection member 83 and the fourth reflection member 84 include, for example, metal films, dielectric multilayer films, and scattering members.

As shown in FIG. 1, the optical integration system 90 is provided at the light exiting side of the light source device 30A. The optical integration system 90 includes a first lens array 91 and a second lens array 92. The optical integration system 90, along with the superimposing system 94, functions as a homogeneous illumination system that homogenizes the intensity distribution of the white light LW emitted from the light source device 30A in the respective light modulation devices 400R, 400G, 400B as illuminated regions. The white light LW emitted from the light source device 30A enters the first lens array 91.

The first lens array 91 includes a plurality of first lenses 91a. The plurality of first lenses 91a are arranged in a matrix form in a plane parallel to the YZ-plane orthogonal to the optical axis AX1 of the illumination device 20. The plurality of first lenses 91a divide the white light LW emitted from the light source device 30A into a plurality of partial luminous fluxes. The shapes of the respective first lenses 91a are rectangular shapes substantially similar to the shapes of the image formation areas of the light modulation devices 400R, 400G, 400B. Accordingly, the respective partial luminous fluxes emitted from the first lens array 91 efficiently enter the image formation areas of the light modulation devices 400R, 400G, 400B.

The white light LW emitted from the first lens array 91 travels toward the second lens array 92. The second lens array 92 is disposed to face the first lens array 91. The second lens array 92 includes a plurality of second lenses 92a corresponding to the plurality of first lenses 91a of the first lens array 91. The second lens array 92, along with the superimposing system 94, forms respective images of the plurality of first lenses 91a of the first lens array 91 in the vicinities of the image formation areas of the light modulation devices 400R, 400G, 400B. The plurality of second lenses 92a are arranged in a matrix form in a plane parallel to the YZ-plane orthogonal to the optical axis AX1 of the illumination device 20. The superimposing system 94 includes a single convex lens.

In the embodiment, each first lens 91a of the first lens array 91 and each second lens 92a of the second lens array 92 have the same size as each other, however, may have different sizes from each other. Further, in the embodiment, the first lenses 91a of the first lens array 91 and the second lenses 92a of the second lens array 92 are arranged in positions where the optical axes thereof are aligned with each other, however, may be arranged in positions where the optical axes thereof deviate from each other.

The polarization conversion element 93 converts the polarization direction of the white light LW emitted from the second lens array 92. Specifically, the polarization conversion element 93 converts each of the partial luminous fluxes of the white light LW divided by the first lens array 91 and then emitted from the second lens array 92 into a linearly-polarized light. The polarization conversion element 93 includes a polarization separation layer (not shown), a reflection layer (not shown), and a retardation layer (not shown). The polarization separation layer transmits one linearly-polarized component of the polarization components contained in the white light LW emitted from the light source device 30A without change, and reflects the other linearly-polarized component in a direction perpendicular to the optical axis AX1. The reflection layer reflects the other linearly-polarized component reflected by the polarization separation layer in a direction parallel to the optical axis AX1. The retardation layer converts the other linearly-polarized component reflected by the reflection layer into the one linearly-polarized component.

As below, a behavior of light in the light source device 30A of the embodiment will be described.

As shown in FIG. 3, in the light source device 30A, the first excitation light E1 emitted from the first light source 41 is transmitted through the first optical layer 61 and the first light-transmissive member 73 and enters the first wavelength conversion element 51. Note that part of the first excitation light E1 is backscattered by the front surface 51a of the first wavelength conversion element 51 and travels toward the first light source 41 side, and is reflected by the first optical layer 61 or the first light-transmissive member 73 and then enters the first wavelength conversion element 51.

When the first excitation light E1 enters the first wavelength conversion element 51, the phosphor contained in the first wavelength conversion element 51 is excited, and yellow fluorescence Y is emitted from a certain light emission point. Concurrently, the first excitation light E1 entering the phosphor is diffused and propagates to a region wider than the incident region, and thereby, the so-called blurring of the yellow fluorescence Y that the width of the emission region of the yellow fluorescence Y becomes wider occurs.

The yellow fluorescence Y entering the front surface 51a and the back surface 51b of the first wavelength conversion element 51 at an incidence angle smaller than the critical angle is emitted from the first wavelength conversion element 51, enters the first light-transmissive member 73, and propagates inside the first light-transmissive member 73. Concurrently, fluorescence Y1 traveling toward the +X side is reflected by the first optical layer 61, propagates inside the first light-transmissive member 73, and is emitted to the outside from the end surface of the first light-transmissive member 73 at the second end surface 51d side.

On the other hand, yellow fluorescence Y2 traveling toward the −X side and reaching the first reflection member 81 is reflected by the first reflection member 81, then travels toward the +X side, and enters the first wavelength conversion element 51 again. In the embodiment, since the first wavelength conversion element 51 is formed using the transparent phosphor, scattering of the yellow fluorescence Y2 does not occur inside the first wavelength conversion element 51, and the traveling direction of yellow fluorescence Y2 is not changed inside the first wavelength conversion element 51. The refractive index of the first wavelength conversion element 51 and the refractive index of the second wavelength conversion element 52 are substantially the same. Accordingly, the yellow fluorescence Y2 is not substantially refracted at the interface between the first wavelength conversion element 51 and the second wavelength conversion element 52, but enters the second wavelength conversion element 52 from the first wavelength conversion element 51. The yellow fluorescence Y2 entering the second wavelength conversion element 52 enters the second light-transmissive member 74, and is emitted to the outside from the end surface of the second light-transmissive member 74 at the second end surface 52d side.

Of the yellow fluorescence Y emitted from the first wavelength conversion element 51, yellow fluorescence Y0 perpendicularly entering the first optical layer 61 is repeatedly reflected between the first optical layer 61 and the second optical layer 62 because the first wavelength conversion element 51 is formed using the transparent phosphor and the traveling direction of the yellow fluorescence Y0 is not changed inside the first wavelength conversion element 51. Note that part of the yellow fluorescence Y0 is absorbed by the phosphor while propagating inside the first wavelength conversion element 51 and the second wavelength conversion element 52 and results in a loss.

Yellow fluorescence Y3 entering the front surface 51a of the first wavelength conversion element 51 at an incidence angle equal to or larger than the critical angle is totally reflected by the front surface 51a of the first wavelength conversion element 51. Here, the first wavelength conversion element 51 and the second wavelength conversion element 52 are formed using the transparent phosphor and the traveling direction of the yellow fluorescence Y3 is not changed inside the first wavelength conversion element 51 and the second wavelength conversion element 52, and thereby, the incidence angle of the yellow fluorescence Y3 with respect to the front surface 52a of the second wavelength conversion element 52 is not changed. Accordingly, the yellow fluorescence Y3 is repeatedly totally reflected between the front surface 51a of the first wavelength conversion element 51 and the front surface 52a of the second wavelength conversion element 52, and emitted from the second end surface 51d or the second end surface 52d.

On the other hand, the second excitation light E2 emitted from the second light source 42 is transmitted through the second optical layer 62 and the second light-transmissive member 74 and enters the second wavelength conversion element 52. Part of the second excitation light E2 is backscattered by the front surface 52a of the second wavelength conversion element 52 and travels toward the second light source 42 side, and is reflected by the second optical layer 62 or the second light-transmissive member 74 and then enters the second wavelength conversion element 52.

When the second excitation light E2 enters the second wavelength conversion element 52, the phosphor contained in the second wavelength conversion element 52 is excited, and blue fluorescence B is emitted from a certain light emission point. Concurrently, the second excitation light E2 entering the phosphor is diffused and propagates to a region wider than the incident region, and thereby, the so-called blurring of the blue fluorescence B that the width of the emission region of the blue fluorescence B becomes wider occurs.

Blue fluorescence B entering the front surface 52a of the second wavelength conversion element 52 at an incidence angle smaller than the critical angle is emitted from the second wavelength conversion element 52, enters the second light-transmissive member 74, and propagates inside the second light-transmissive member 74. Concurrently, blue fluorescence B1 traveling toward the +X side is emitted to the outside from the end surface of the second light-transmissive member 74 at the second end surface 52d side. Alternatively, the blue fluorescence traveling toward the +X side is reflected by the second optical layer 62, then, propagates inside the second light-transmissive member 74, and is emitted to the outside from the end surface of the second light-transmissive member 74 at the second end surface 52d side.

On the other hand, blue fluorescence B2 traveling toward the −X side and reaching the first reflection member 81 is reflected by the first reflection member 81, then travels toward the +X side, is reflected by the second optical layer 62, then, propagates inside the second light-transmissive member 74, and is emitted to the outside from the end surface of the second light-transmissive member 74 at the second end surface 52d side.

Of the blue fluorescence B converted by the second wavelength conversion element 52, fluorescence B3 enters the first wavelength conversion element 51 from the back surface 52b of the second wavelength conversion element 52. Further, other blue fluorescence B4 is emitted to the second light-transmissive member 74, reflected by the second optical layer 62, then, propagates inside the second wavelength conversion element 52, and enters the first wavelength conversion element 51 from the back surface 52b of the second wavelength conversion element 52. The blue fluorescence B3, B4 entering the first wavelength conversion element 51 excites the yellow phosphor contained in the first wavelength conversion element 51. Thereby, the blue fluorescence B3, B4 is converted into yellow fluorescence Y, and the yellow fluorescence Y is emitted from a certain light emission point of the first wavelength conversion element 51.

As described above, the light source device 30A can emit the white light LW containing the yellow fluorescence Y converted by the first wavelength conversion element 51 and the blue fluorescence B converted by the second wavelength conversion element 52 to the outside from the extraction opening 33k of the housing 31.

As shown in FIG. 2, in a plan view in the X-axis direction as the normal direction of the second end surface 52d of the second wavelength conversion element 52, the extraction opening 33k overlaps with the first light guide portion 71, the first wavelength conversion element 51, the second wavelength conversion element 52, and the second light guide portion 72. Accordingly, the end surface of the first light-transmissive member 73 at the second end surface 51d side, the second end surface 51d of the first wavelength conversion element 51, the second end surface 52d of the second wavelength conversion element 52, and the end surface of the second light-transmissive member 74 at the second end surface 52d side are exposed to the outside through the extraction opening 33k. The extraction opening 33k may be closed by a lid including a light-transmissive member so as not to expose the respective end surfaces to the outside. However, when the lid is provided, some of the yellow fluorescence Y and the blue fluorescence B may be reflected by the surface of the lid and not be extracted to the outside. Therefore, it is desirable not to provide the lid in order to increase the extraction efficiency of the yellow fluorescence Y and the blue fluorescence B. In the example of FIG. 2, the extraction opening 33k also overlaps with the first optical layer 61 and the second optical layer 62, however, the opening does not necessarily overlap with the first optical layer 61 or the second optical layer 62.

As described above, from the light source device 30A, the white light LW emitted from the end surface of the first light-transmissive member 73 at the second end surface 51d side, the second end surface 51d of the first wavelength conversion element 51, the second end surface 52d of the second wavelength conversion element 52, and the end surface of the second light-transmissive member 74 at the second end surface 52d side can be extracted to the outside through the minimum extraction opening 33k. Thereby, etendue of the white light LW is smaller in the light source device 30A, and the loss of the white light LW in the optical members including the optical integration system 90 disposed downstream of the light source device 30A can be reduced. As a result, the use efficiency of the white light LW in the light source device 30A can be increased.

In addition, the ratio between the thickness of the first wavelength conversion element 51 and the thickness of the second wavelength conversion element 52 along the arrangement direction (Y-axis direction) in which the first wavelength conversion element 51 and the second wavelength conversion element 52 are arranged is changed, and thereby, the ratio between the amount of the yellow fluorescence Y converted by the first wavelength conversion element 51 and the amount of the blue fluorescence B converted by the second wavelength conversion element 52 can be changed. Accordingly, the color temperature of the white light LW emitted from the light source device 30A can be adjusted. As a result, the color of the image projected from the projector 10 can be adjusted. At the same time, the ratio between the amount of the first excitation light E1 from the first light source 41 and the amount of the second excitation light E2 from the second light source 42 is changed, and thereby, the color temperature of the white light LW may be adjusted.

### Effects of First Embodiment

The light source device 30A of the embodiment includes the first light source 41 that emits the first excitation light E1, the first wavelength conversion element 51 that converts the first excitation light E1 into the yellow fluorescence Y, the first optical layer 61 that is disposed between the first light source 41 and the first wavelength conversion element 51 and transmits the first excitation light E1 and reflects the yellow fluorescence Y, the first light guide portion 71 that is disposed between the first optical layer 61 and the first wavelength conversion element 51 and guides the yellow fluorescence Y converted by the first wavelength conversion element 51, the second light source 42 that emits the second excitation light E2, the second wavelength conversion element 52 that converts the second excitation light E2 into the blue fluorescence B, the second optical layer 62 that is disposed between the second light source 42 and the second wavelength conversion element 52 and transmits the second excitation light E2 and reflects the blue fluorescence B, the second light guide portion 72 that is disposed between the second optical layer 62 and the second wavelength conversion element 52 and guides the blue fluorescence B converted by the second wavelength conversion element 52, and the first reflection member 81 that reflects the first excitation light E1, the yellow fluorescence Y, the second excitation light E2, and the blue fluorescence B. The first wavelength conversion element 51 includes the front surface 51a entered by the first excitation light E1 via the first optical layer 61 and the first light guide portion 71, and the first end surface 51c and the second end surface 51d that cross the front surface 51a and face opposite sides to each other. The second wavelength conversion element 52 includes the front surface 52a entered by the second excitation light E2 via the second optical layer 62 and the second light guide portion 72, and the first end surface 52c and the second end surface 52d that cross the front surface 52a and face opposite sides to each other. The first reflection member 81 is disposed in the region at the first end surface 51c side of the first light guide portion 71 and the region at the first end surface 52c side of the second light guide portion 72. The second wavelength conversion element 52 is disposed at the side opposite to the first light source 41 with respect to the first wavelength conversion element 51. The yellow fluorescence Y converted by the first wavelength conversion element 51 travels through the first light guide portion 71 and is emitted from the region of the first light guide portion 71 at the second end surface 51d side, and the blue fluorescence B converted by the second wavelength conversion element 52 travels through the second light guide portion 72 and is emitted from the region of the second light guide portion 72 at the second end surface 52d side.

As described above, according to the light source device 30A of the embodiment, the yellow fluorescence Y generated in the first wavelength conversion element 51 travels through the first light guide portion 71, the blue fluorescence B generated in the second wavelength conversion element 52 travels through the second light guide portion 72, and are emitted from the regions of the respective light guide portions 71 and 72 at the second end surface 51d and 52d sides. Therefore, as compared with the light source device of related art in which all the fluorescence propagates inside the wavelength conversion element, the loss of the yellow fluorescence Y and the blue fluorescence B is smaller, and the use efficiency of the yellow fluorescence Y and the blue fluorescence B can be increased. Further, the light source device 30A of the embodiment can efficiently emit the white light LW formed by combination of the yellow fluorescence Y and the blue fluorescence B.

The projector 10 of the embodiment includes the light source device 30A, the light modulation devices 400R, 400G, 400B that modulate the light emitted from the light source device 30A, and the projection optical device 600 that projects the lights modulated by the light modulation devices 400R, 400G, 400B.

According to the configuration, since the light source device 30A emits the white light LW, with only one light source device, the projector 10 having the highly efficient and simple configuration can be realized.

### Second Embodiment

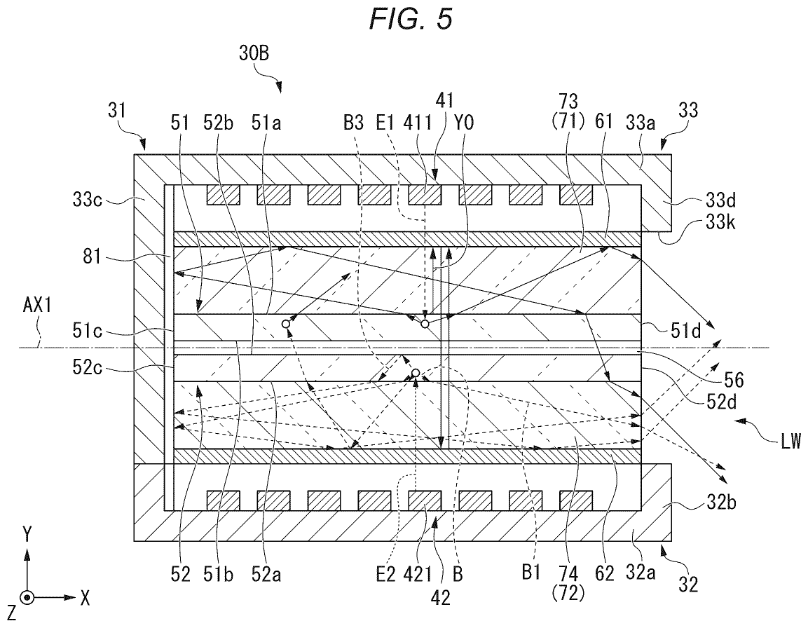

As below, a second embodiment of the present disclosure will be described using FIG. 5.

Since the basic configuration of the light source device of the second embodiment is the same as that of the first embodiment, the description of the basic configuration of the light source device is omitted.

FIG. 5 is a cross-sectional view of a light source device 30B of the second embodiment cut along the XY-plane. In FIG. 5, the component elements common to those in the drawings used in the first embodiment have the same signs and the description thereof is omitted.

As shown in FIG. 5, the light source device 30B of the embodiment includes a housing 31, a first light source 41, a first wavelength conversion element 51, a first optical layer 61, a first light guide portion 71, a second light source 42, a second wavelength conversion element 52, a second optical layer 62, a second light guide portion 72, a first reflection member 81, a third reflection member (not shown), and a fourth reflection member (not shown).

In the light source device 30A of the first embodiment, the first wavelength conversion element 51 and the second wavelength conversion element 52 are bonded to each other via the optical adhesive. On the other hand, in the light source device 30B of the embodiment, the first wavelength conversion element 51 and the second wavelength conversion element 52 are not joined to each other, but separated from each other. Air is present in a space between the first wavelength conversion element 51 and the second wavelength conversion element 52. That is, an air layer 56 is provided between the first wavelength conversion element 51 and the second wavelength conversion element 52.

The other configurations of the light source device 30B are the same as those of the light source device 30A of the first embodiment.

### Effects of Second Embodiment

In the embodiment, the same effects as those of the first embodiment can be obtained. That is, the yellow fluorescence Y propagates through the first light guide portion 71 and the blue fluorescence B propagates through the second light guide portion 72, and thereby, the light source device 30B with the smaller loss of the yellow fluorescence Y and the blue fluorescence B and the higher use efficiency of the yellow fluorescence Y and the blue fluorescence B can be realized and the light source device 30B that can efficiently emit the white light LW can be realized.

In the first embodiment, since the first wavelength conversion element 51 and the second wavelength conversion element 52 are bonded to each other, part of the blue fluorescence B generated in the second wavelength conversion element 52 enters the first wavelength conversion element 51 and is converted into the yellow fluorescence Y. In this case, the amount of the blue fluorescence B decreases, and the yellow fluorescence Y is generated through the two wavelength conversions of the conversion from the second excitation light E2 into the blue fluorescence B in the second wavelength conversion element 52 and the conversion from the blue fluorescence B into the yellow fluorescence Y in the first wavelength conversion element 51. Accordingly, there is a problem that the wavelength conversion efficiency becomes lower. Further, when part of the yellow fluorescence Y generated in the first wavelength conversion element 51 enters the second wavelength conversion element 52, a loss of yellow fluorescence Y occurs.

On the other hand, in the embodiment, since the air layer 56 is provided between the first wavelength conversion element 51 and the second wavelength conversion element 52, a difference in refractive index between the back surfaces 51b, 52b of the respective wavelength conversion elements 51, 52 is larger than that in the first embodiment, and critical angles in the back surfaces 51b, 52b of the respective wavelength conversion elements 51, 52 are larger than those in the first embodiment. Accordingly, when the fluorescence Y or B generated by one wavelength conversion element 51 or 52 reaches the back surface 51b or 52b of the wavelength conversion element 51 or 52, it is easier for the fluorescence to be totally reflected at the interface with the air layer 56 and harder to enter the other wavelength conversion element 52 or 51. Thereby, the fluorescence B3 shown in FIG. 3 of the first embodiment enters the first wavelength conversion element 51, however, as shown in FIG. 5, the fluorescence B3 of the embodiment is totally reflected by the back surface 52b of the second wavelength conversion element 52, but does not enter the first wavelength conversion element 51. Therefore, according to the light source device 30A of the embodiment, the amount of the blue fluorescence B can be secured and the decrease in wavelength conversion efficiency can be suppressed. In addition, since the entry of the yellow fluorescence Y into the second wavelength conversion element 52 is suppressed, absorption of the yellow fluorescence Y by the second wavelength conversion element 52 is suppressed, and the decrease in amount of the yellow fluorescence Y can be suppressed.

### Third Embodiment

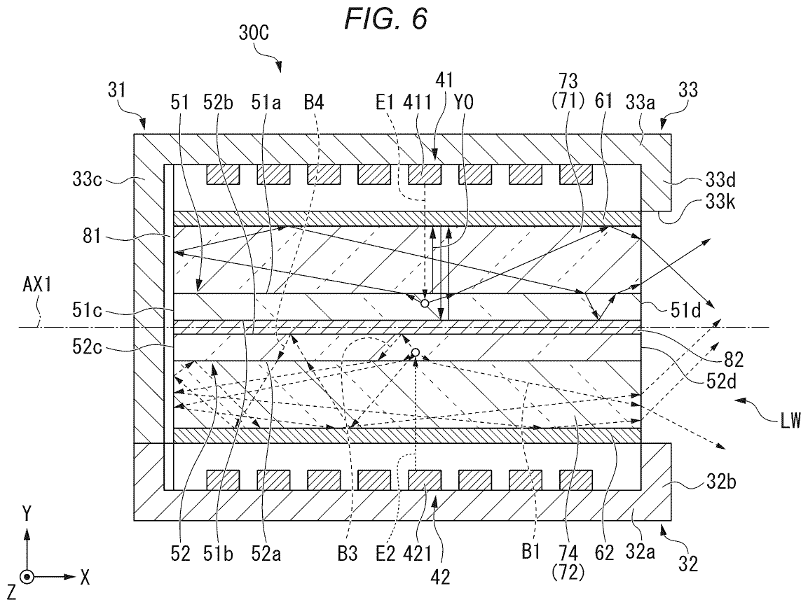

As below, a third embodiment of the present disclosure will be described using FIG. 6.

Since the basic configuration of the light source device of the third embodiment is the same as that of the first embodiment, the description of the basic configuration of the light source device is omitted.

FIG. 6 is a cross-sectional view of a light source device 30C of the third embodiment cut along the XY-plane. In FIG. 6, the component elements common to those in the drawings used in the first embodiment have the same signs and the description thereof is omitted.

As shown in FIG. 6, the light source device 30C of the embodiment includes a housing 31, a first light source 41, a first wavelength conversion element 51, a first optical layer 61, a first light guide portion 71, a second light source 42, a second wavelength conversion element 52, a second optical layer 62, a second light guide portion 72, a first reflection member 81, a second reflection member 82, a third reflection member (not shown), and a fourth reflection member (not shown).

In the light source device 30A of the first embodiment, the first wavelength conversion element 51 and the second wavelength conversion element 52 are bonded to each other via the optical adhesive. On the other hand, in the light source device 30C of the embodiment, the second reflection member 82 is disposed between the first wavelength conversion element 51 and the second wavelength conversion element 52. The second reflection member 82 reflects the first excitation light E1, the yellow fluorescence Y, the second excitation light E2, and the blue fluorescence B. The second reflection member 82 includes, for example, a metal film or a dielectric multilayer film.

The other configurations of the light source device 30C are the same as those of the light source device 30A of the first embodiment.

### Effects of Third Embodiment

In the embodiment, the same effects as those of the first embodiment can be obtained. That is, the yellow fluorescence Y propagates through the first light guide portion 71 and the blue fluorescence B propagates through the second light guide portion 72, and thereby, the light source device 30C with the smaller loss of the yellow fluorescence Y and the blue fluorescence B and the higher use efficiency of the yellow fluorescence Y and the blue fluorescence B can be realized and the light source device 30C that can efficiently emit the white light LW can be realized.

In the embodiment, since the second reflection member 82 is provided between the first wavelength conversion element 51 and the second wavelength conversion element 52, when the fluorescence Y or B generated in one wavelength conversion element 51 or 52 reaches the back surface 51b or 52b of the wavelength conversion element 51 or 52, the fluorescence is reflected by the second reflection member 82, but does not enter the other wavelength conversion element 52 or 51. Thereby, the fluorescence B3, B4 shown in FIG. 3 of the first embodiment enters the first wavelength conversion element 51, however, as shown in FIG. 6, the fluorescence B3, B4 of the embodiment is reflected by the second reflection member 82, but does not enter the wavelength conversion element 51. Therefore, the amount of the blue fluorescence B can be secured and the decrease in wavelength conversion efficiency can be suppressed. Further, since the yellow fluorescence Y is reflected by the second reflection member 82, but does not enter the second wavelength conversion element 52, absorption of the yellow fluorescence Y can be reduced and the decrease in amount of the yellow fluorescence Y can be suppressed.

### Fourth Embodiment

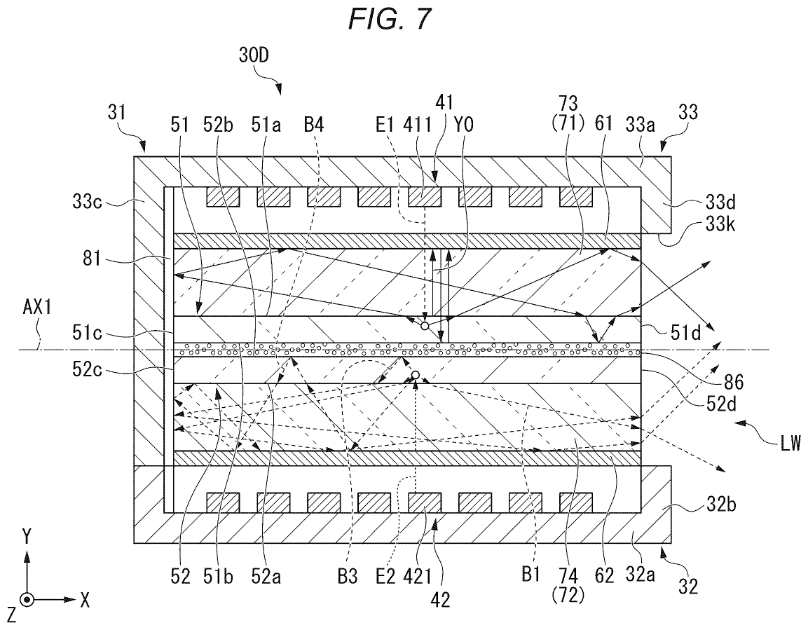

As below, a fourth embodiment of the present disclosure will be described using FIG. 7.

Since the basic configuration of the light source device of the fourth embodiment is the same as that of the first embodiment, the description of the basic configuration of the light source device is omitted.

FIG. 7 is a cross-sectional view of a light source device 30D of the fourth embodiment cut along the XY-plane. In FIG. 7, the component elements common to those in the drawings used in the first embodiment have the same signs and the description thereof is omitted.

As shown in FIG. 7, the light source device 30D of the embodiment includes a housing 31, a first light source 41, a first wavelength conversion element 51, a first optical layer 61, a first light guide portion 71, a second light source 42, a second wavelength conversion element 52, a second optical layer 62, a second light guide portion 72, a first reflection member 81, a scattering layer 86, a third reflection member (not shown), and a fourth reflection member (not shown).

In the light source device 30A of the first embodiment, the first wavelength conversion element 51 and the second wavelength conversion element 52 are bonded to each other via the optical adhesive. On the other hand, in the light source device 30D of the embodiment, the scattering layer 86 is disposed between the first wavelength conversion element 51 and the second wavelength conversion element 52. The scattering layer 86 reflects the first excitation light E1, the yellow fluorescence Y, the second excitation light E2, and the blue fluorescence B, and changes emission angles of the respective lights. The scattering layer 86 is formed using, for example, a scattering material containing barium sulfate.

The other configurations of the light source device 30D are the same as those of the light source device 30B of the first embodiment.

### Effects of Fourth Embodiment

In the embodiment, the same effects as those of the first embodiment can be obtained. That is, the yellow fluorescence Y propagates through the first light guide portion 71 and the blue fluorescence B propagates through the second light guide portion 72, and thereby, the light source device 30D with the smaller loss of the yellow fluorescence Y and the blue fluorescence B and the higher use efficiency of the yellow fluorescence Y and the blue fluorescence B can be realized and the light source device 30D that can efficiently emit the white light LW can be realized.

In the embodiment, since the scattering layer 86 is provided between the first wavelength conversion element 51 and the second wavelength conversion element 52, when the fluorescence Y or B generated in one wavelength conversion element 51 or 52 reaches the back surface 51b or 52b of the wavelength conversion element 51 or 52, the fluorescence is scattered and reflected by the scattering layer 86 and the emission angle is changed, and it is harder for the fluorescence to enter the other wavelength conversion element 52 or 51. Thereby, the fluorescence B3, B4 shown in FIG. 3 of the first embodiment enters the first wavelength conversion element 51, however, as shown in FIG. 7, the fluorescence B3, B4 of the embodiment is scattered by the scattering layer 86, enters the second light-transmissive member 74, not entering the first wavelength conversion element 51, propagates in the second light-transmissive member 74, and is emitted to the outside. Therefore, the amount of the blue fluorescence B can be secured and the decrease in wavelength conversion efficiency can be suppressed. Further, the yellow fluorescence Y is scattered by the scattering layer 86 and it is harder for the fluorescence to enter the second wavelength conversion element 52, and absorption of the yellow fluorescence Y can be reduced and the decrease in amount of the yellow fluorescence Y can be suppressed.

### Fifth Embodiment

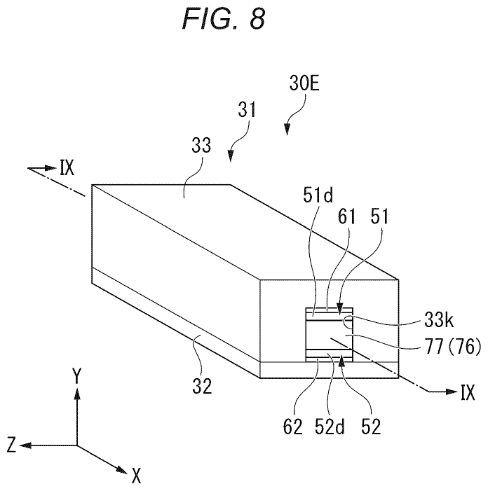

As below, a fifth embodiment of the present disclosure will be described using FIGS. 8 to 10.

Since the basic configuration of the light source device of the fifth embodiment is the same as that of the first embodiment, the description of the basic configuration of the light source device is omitted.

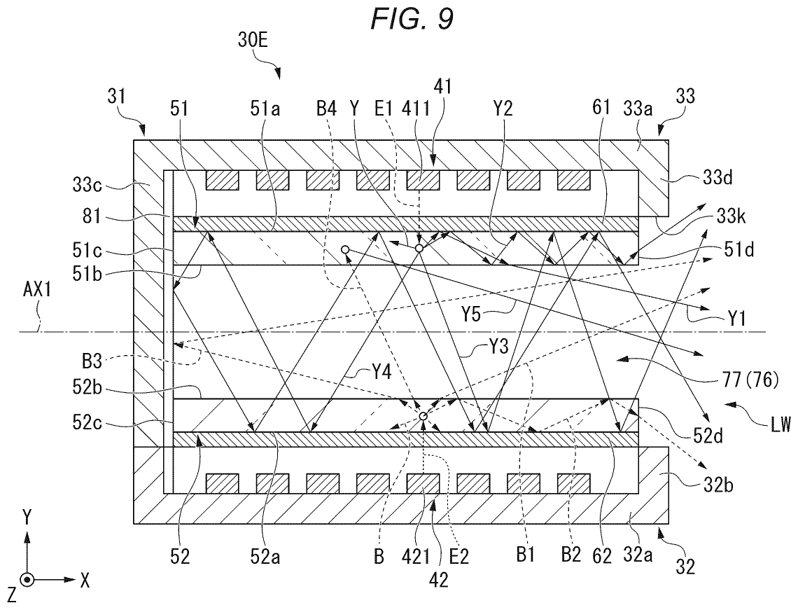

FIG. 8 is a perspective view of a light source device 30E of the fifth embodiment. FIG. 9 is a cross-sectional view of the light source device 30E cut along line IX-IX in FIG. 8. In FIGS. 8 and 9, the component elements common to those in the drawings used in the first embodiment have the same signs and the description thereof is omitted.

As shown in FIGS. 8 and 9, the light source device 30E of the embodiment includes a housing 31, a first light source 41, a first wavelength conversion element 51, a first optical layer 61, a second light source 42, a second wavelength conversion element 52, a second optical layer 62, a light guide portion 76, a first reflection member 81, a third reflection member (not shown), and a fourth reflection member (not shown).

As shown in FIG. 9, in the light source device 30E of the embodiment, the first optical layer 61 is disposed on the front surface 51a of the first wavelength conversion element 51. That is, the first optical layer 61 and the first wavelength conversion element 51 are in contact with each other. The second optical layer 62 is disposed on the front surface 52a of the second wavelength conversion element 52. That is, the second optical layer 62 and the second wavelength conversion element 52 are in contact with each other.

The light guide portion 76 is disposed between the first wavelength conversion element 51 and the second wavelength conversion element 52. The light guide portion 76 includes an air layer 77. That is, the first wavelength conversion element 51 and the second wavelength conversion element 52 are disposed apart from each other, and air is present between the first wavelength conversion element 51 and the second wavelength conversion element 52. The light guide portion 76 guides the yellow fluorescence Y converted by the first wavelength conversion element 51 and the blue fluorescence B converted by the second wavelength conversion element 52. The second wavelength conversion element 52 is disposed at the side opposite to the first light source 41 with respect to the first wavelength conversion element 51. The first reflection member 81 is disposed in the region at the first end surface 51c side of the light guide portion 76.

As shown in FIG. 8, in a plan view in the X-axis direction as the normal direction of the second end surface 51d of the first wavelength conversion element 51, the extraction opening 33k overlaps with the first wavelength conversion element 51, the light guide portion 76, and the second wavelength conversion element 52. The second end surface 51d of the first wavelength conversion element 51, the region of the light guide portion 76 at the second end surface 51d side, and the second end surface 52d of the second wavelength conversion element 52 are exposed to the outside through the extraction opening 33k. In the example of FIG. 8, the extraction opening 33k also overlaps with the first optical layer 61 and the second optical layer 62, however, the opening does not necessarily overlap with the first optical layer 61 or the second optical layer 62.

The other configurations of the light source device 30E are the same as those of the light source device 30A of the first embodiment.

As below, a behavior of light in the light source device 30E of the embodiment will be described.

As shown in FIG. 9, in the light source device 30E, the first excitation light E1 emitted from the first light source 41 is transmitted through the first optical layer 61 and enters the first wavelength conversion element 51. When the first excitation light E1 enters the first wavelength conversion element 51, the phosphor contained in the first wavelength conversion element 51 is excited, and yellow fluorescence Y is emitted from a certain light emission point.

The yellow fluorescence Y1 entering the back surface 51b of the first wavelength conversion element 51 at an incidence angle smaller than the critical angle is emitted from the first wavelength conversion element 51 and travels through the air layer 77, and then is emitted to the outside from the region of the air layer 77 at the second end surface 51d side. On the other hand, the yellow fluorescence Y2 entering the back surface 51b of the first wavelength conversion element 51 at an incidence angle equal to or larger than the critical angle is not changed in traveling direction because the first wavelength conversion element 51 is formed using the transparent phosphor, travels inside the first wavelength conversion element 51 while being repeatedly totally reflected by the back surface 51b of the first wavelength conversion element 51 and reflected by the first optical layer 61, and then, is emitted to the outside from the second end surface 51d of the first wavelength conversion element 51.

The yellow fluorescence Y3 traveling through the air layer 77 toward the +X side and entering the second wavelength conversion element 52 travels through the air layer 77 while being repeatedly reflected by the second optical layer 62 and reflected by the first optical layer 61, and then, is emitted to the outside from the region of the air layer 77 at the second end surface 51d side. The yellow fluorescence Y4 traveling through the air layer 77 toward the −X side and entering the second wavelength conversion element 52 travels through the air layer 77 while being repeatedly reflected by the second optical layer 62 and reflected by the first optical layer 61, then, is reflected by the first reflection member 81, travels through the air layer 77 while being repeatedly reflected by the second optical layer 62 and reflected by the first optical layer 61 again, and then, is emitted to the outside from the region of the air layer 77 at the second end surface 51d side. Note that part of the yellow fluorescence Y3, Y4 entering the second wavelength conversion element 52 is absorbed by the phosphor contained in the second wavelength conversion element 52 and results in a loss.

On the other hand, the second excitation light E2 emitted from the second light source 42 is transmitted through the second optical layer 62 and enters the second wavelength conversion element 52. When the second excitation light E2 enters the second wavelength conversion element 52, the phosphor contained in the second wavelength conversion element 52 is excited, and blue fluorescence B is emitted from a certain light emission point.

The blue fluorescence B1 entering the back surface 52b of the second wavelength conversion element 52 at an incidence angle smaller than the critical angle is emitted from the second wavelength conversion element 52 and travels through the air layer 77, and then, is emitted to the outside from the region of the air layer 77 at the second end surface 52d side. On the other hand, the blue fluorescence B2 entering the back surface 52b of the second wavelength conversion element 52 at an incidence angle equal to or larger than the critical angle is not changed in traveling direction because the second wavelength conversion element 52 is formed using the transparent phosphor, travels inside the second wavelength conversion element 52 while being repeatedly totally reflected by the back surface 52b of the second wavelength conversion element 52 and reflected by the second optical layer 62, and then, is emitted to the outside from the second end surface 52d of the second wavelength conversion element 52.

The blue fluorescent light B3 traveling through the air layer 77 toward the −X side and entering the first reflection member 81 is reflected by the first reflection member 81, then, travels through the air layer 77, and is emitted to the outside from the region of the air layer 77 at the second end surface 52d side. The blue fluorescent light B4 emitted to the air layer 77 and entering the first wavelength conversion element 51 is converted into yellow fluorescence Y5 by the phosphor contained in the first wavelength conversion element 51 and emitted to the outside.

As described above, the yellow fluorescence Y converted by the first wavelength conversion element 51 is emitted to the outside from the light guide portion 76 including the air layer 77 and the first wavelength conversion element 51. The blue fluorescence B converted by the second wavelength conversion element 52 is emitted to the outside from the light guide portion 76 including the air layer 77 and the second wavelength conversion element 52. That is, the yellow fluorescence Y converted by the first wavelength conversion element 51 and the blue fluorescence B converted by the second wavelength conversion element 52 travel through the light guide portion 76 and are emitted from the region of the light guide portion 76 at the second end surface 51d side. As described above, the light source device 30E can emit the white light LW containing the yellow fluorescence Y converted by the first wavelength conversion element 51 and the blue fluorescence B converted by the second wavelength conversion element 52 to the outside from the extraction opening 33k of the housing 31.

### Effects of Fifth Embodiment

In the embodiment, the same effects as those of the first embodiment can be obtained. That is, the yellow fluorescence Y and the blue fluorescence B propagate through the light guide portion 76, and thereby, the light source device 30E with the smaller loss of the yellow fluorescence Y and the blue fluorescence B and the higher use efficiency of the yellow fluorescence Y and the blue fluorescence B can be realized and the light source device 30E that can efficiently emit the white light LW can be realized.

In the first to fourth embodiments, the yellow fluorescence Y generated in the first wavelength conversion element 51 is mainly emitted from the region of the first light guide portion 71 in the extraction opening 33k, and the blue fluorescence B generated in the second wavelength conversion element 52 is mainly emitted from the region of the second light guide portion 72 in the extraction opening 33k. As described above, since the emission position of the yellow fluorescence Y and the emission position of the blue fluorescence B are different from each other, color unevenness may occur in the optical system downstream of the light source device. On the other hand, in the embodiment, the yellow fluorescence Y generated in the first wavelength conversion element 51 and the blue fluorescence B generated in the second wavelength conversion element 52 are emitted from the light guide portion 76 common to the lights. Accordingly, the yellow fluorescence Y and the blue fluorescence B are mixed and emitted from the same position, and thereby, color unevenness in the optical system downstream of the light source device 30E can be suppressed.

In the embodiment, since the light guide portion 76 guiding the yellow fluorescence Y and the blue fluorescence B includes the air layer 77, the following effects can be obtained.

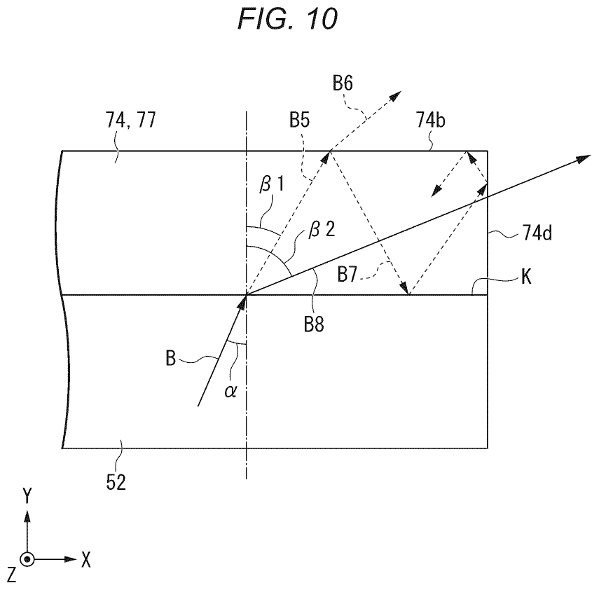

FIG. 10 is a schematic diagram showing functions of the light source device 30E of the embodiment. The behavior of the yellow fluorescence Y and the behavior of the blue fluorescent light B with respect to the air layer 77 are substantially the same and, here, the behavior of the blue fluorescent light B with respect to the air layer 77 is shown and described.

In the case where the light-transmissive member is disposed in the light guide portion as in the first to fourth embodiments, as shown in FIG. 10, when the blue fluorescence B generated in the second wavelength conversion element 52 reaches an interface K between the second wavelength conversion element 52 and the light-transmissive member 74, if an incidence angle α of the blue fluorescence B with respect to the interface K is smaller than the critical angle, the blue fluorescence B is not reflected at the interface K, but refracted at a refraction angle β1 and enters the light-transmissive member 74. Here, when the material of the second wavelength conversion element 52 is SBCA and the material of the light-transmissive member 74 is quartz, the refractive index of the SBCA is, for example, about 1.5 to 2.0, and the refractive index of quartz is about 1.4, and a difference in refractive index between the second wavelength conversion element 52 and the light-transmissive member 74 is about 0.1 to 0.6 and the difference in refractive index is smaller.

In this case, the refraction angle β1 is not so large with respect to the incidence angle α, and blue fluorescence B5 entering the light-transmissive member 74 travels in a direction nearly perpendicular to the interface K, that is, a direction forming a large angle with respect to the X-axis. As a result, the blue fluorescence B5 may leak to the outside from a surface 74b of the light-transmissive member 74 opposite to the interface K and result in a leakage light B6. Or, if the blue fluorescence B5 becomes fluorescence B7 reflected by the surface 74b of the light-transmissive member 74, when the fluorescence propagates through the light-transmissive member 74 in the X-axis direction and reaches an end surface 74d of the light-transmissive member 74, the incidence angle of the blue fluorescence B7 with respect to the end surface 74d is larger, and thus, the blue fluorescence B7 may be reflected by the end surface 74d and not be emitted from the end surface 74d and the extraction efficiency of the blue fluorescence B may be lower.

On the other hand, when the air layer 77 is adjacent to the second wavelength conversion element 52 as in the embodiment, the refractive index of the SBCA is, for example, about 1.5 to 2.0 and the refractive index of air is 1.0, and a difference in refractive index between the second wavelength conversion element 52 and the air layer 77 is about 0.5 to 1.0 and the difference in refractive index is larger than those in the first to fourth embodiments. Accordingly, a refraction angle β2 is larger than the refraction angle β1, and blue fluorescence B8 entering the air layer 77 travels in a direction forming a smaller angle with respect to the interface K, that is, a direction forming a smaller angle with respect to the X-axis, as compared with a case where the fluorescence enters the light-transmissive member 74. As a result, when the blue fluorescence B8 reaches an interface between the air layer 77 and another substance, it is easier for the fluorescence to be totally reflected and harder to leak to the outside. Further, in the embodiment, since the air layer 77 is opened to the external space in the extraction opening 33k and has no interface of refractive index, the blue fluorescence B8 reaching the extraction opening 33k is not reflected or refracted, but emitted to the external space without change. With respect to the yellow fluorescence Y, the same effects as those of the blue fluorescence B can be obtained. With the above described functions, according to the light source device 30E of the embodiment, the extraction efficiency of the yellow fluorescence Y and the blue fluorescence B can be increased as compared with the first to fourth embodiments.

According to the configuration of the embodiment, since the first wavelength conversion element 51 and the second wavelength conversion element 52 are disposed apart from each other, the wavelength conversion elements 51 and 52 can be efficiently cooled. As a result, the temperature rise of the respective wavelength conversion elements 51 and 52 can be suppressed, and the higher wavelength conversion efficiency can be maintained.

### Sixth Embodiment

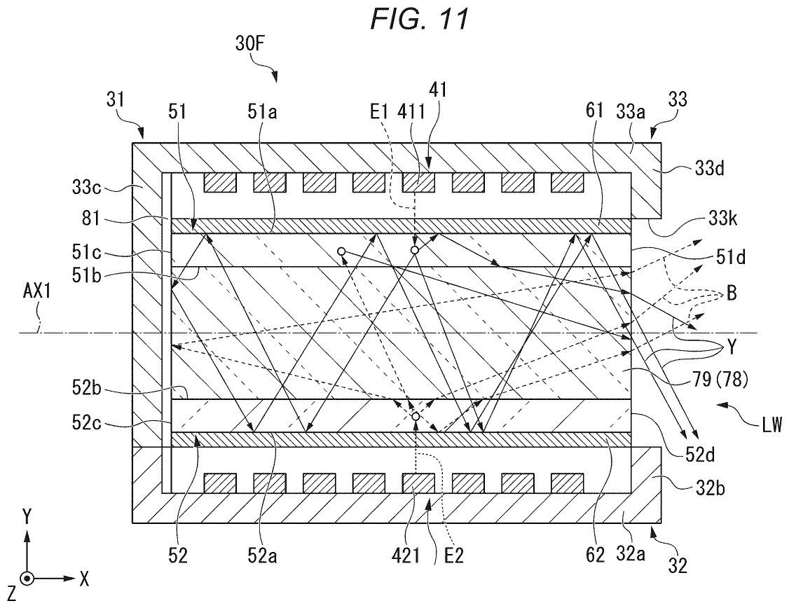

As below, a sixth embodiment of the present disclosure will be described using FIG. 11.

Since the basic configuration of the light source device of the sixth embodiment is the same as that of the fifth embodiment, the description of the basic configuration of the light source device is omitted.

FIG. 11 is a cross-sectional view of a light source device 30F of the sixth embodiment cut along the XY-plane. In FIG. 11, the component elements common to those in the drawings used in the fifth embodiment have the same signs and the description thereof is omitted.

As shown in FIG. 11, the light source device 30F of the embodiment includes a housing 31, a first light source 41, a first wavelength conversion element 51, a first optical layer 61, a second light source 42, a second wavelength conversion element 52, a second optical layer 62, a light guide portion 78, a first reflection member 81, a third reflection member (not shown), and a fourth reflection member (not shown).

In the light source device 30E of the fifth embodiment, the light guide portion 76 includes the air layer 77. On the other hand, in the light source device 30F of the embodiment, a light-transmissive member 79 is disposed in the light guide portion 78. The light-transmissive member 79 transmits the first excitation light E1, the yellow fluorescence Y, the second excitation light E2, and the blue fluorescence B. Like the first light-transmissive member 73 of the first embodiment or the like, the light-transmissive member 79 is formed using a light-transmissive material including, for example, borosilicate glass such as BK7, quartz, synthetic quartz, quartz crystal, SiC, GaN, MgO, YAG, sapphire, and diamond.

The other configurations of the light source device 30F are the same as those of the light source device 30E of the fifth embodiment.

A behavior of light in the light source device 30F is substantially the same as that of the light source device 30E of the fifth embodiment. That is, the yellow fluorescence Y converted by the first wavelength conversion element 51 and the blue fluorescence B converted by the second wavelength conversion element 52 travel inside the light-transmissive member 79 as the light guide portion 78 and are emitted from the end surface of the light-transmissive member 79 at the second end surface 51d side.

### Effects of Sixth Embodiment

In the embodiment, the same effects as those of the first embodiment can be obtained. That is, the yellow fluorescence Y and the blue fluorescence B propagate through the light guide portion 78, and thereby, the light source device 30F with the smaller loss of the yellow fluorescence Y and the blue fluorescence B and the higher use efficiency of the yellow fluorescence Y and the blue fluorescence B can be realized and the light source device 30F that can efficiently emit the white light LW can be realized.

Further, the same effects as those of the fifth embodiment can be obtained. That is, the yellow fluorescence Y and the blue fluorescence B are mainly emitted from the light guide portion 78, and thereby, the color unevenness in the optical system downstream of the light source device 30F can be suppressed. The respective wavelength conversion elements 51 and 52 can be efficiently cooled, and thereby, the higher wavelength conversion efficiency can be maintained.

In the embodiment, since the light guide portion 78 includes the light-transmissive member 79, the differences in refractive index between the respective wavelength conversion elements 51 and 52 and the light guide portion 78 are smaller and the critical angles at the interfaces between the respective wavelength conversion elements 51 and 52 and the light guide portion 78 are larger than those of the fifth embodiment in which the light guide portion 76 includes the air layer 77. Thereby, it is harder for the respective fluorescence Y and B generated in the respective wavelength conversion elements 51 and 52 to be totally reflected at the interfaces with the light guide portion 78 and it is easier for the respective fluorescence Y and B to be extracted to the light guide portion 78. Thereby, the loss due to reabsorption of the respective fluorescence Y and B can be suppressed.

### Seventh Embodiment

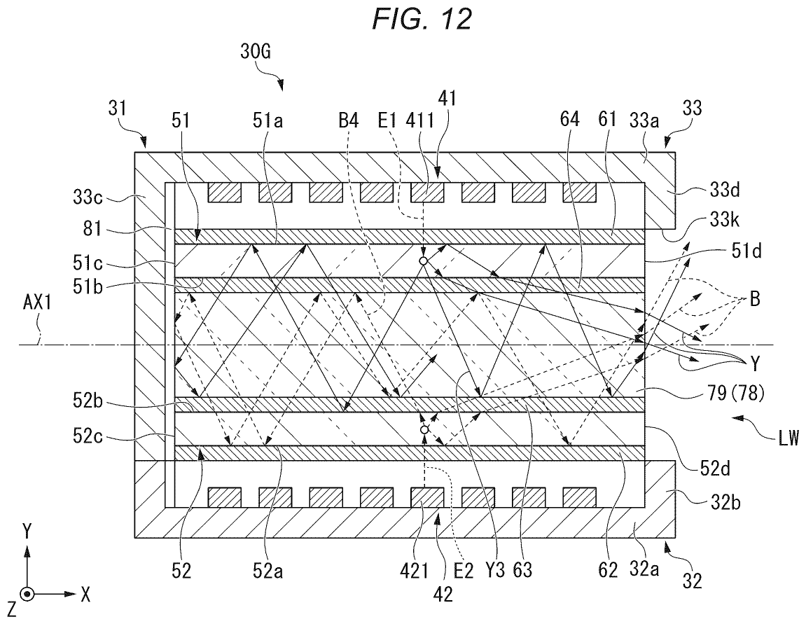

As below, a seventh embodiment of the present disclosure will be described using FIG. 12.

Since the basic configuration of the light source device of the seventh embodiment is the same as that of the sixth embodiment, the description of the basic configuration of the light source device is omitted.

FIG. 12 is a cross-sectional view of a light source device 30G of the seventh embodiment cut along the XY-plane. In FIG. 12, the component elements common to those in FIG. 11 used in the sixth embodiment have the same signs and the description thereof is omitted.

As shown in FIG. 12, the light source device 30G of the embodiment includes a housing 31, a first light source 41, a first wavelength conversion element 51, a first optical layer 61, a second light source 42, a second wavelength conversion element 52, a second optical layer 62, a light guide portion 78, a third optical layer 63, a fourth optical layer 64, a first reflection member 81, a third reflection member (not shown), and a fourth reflection member (not shown).

In the embodiment, the light-transmissive member 79 is disposed in the light guide portion 78. The third optical layer 63 is disposed between the light-transmissive member 79 and the second wavelength conversion element 52. The third optical layer 63 has an optical property of transmitting the first excitation light E1 and the blue fluorescence B and reflecting the yellow fluorescence Y. Note that the third optical layer 63 of the embodiment has an optical property of reflecting the second excitation light E2, however, may have an optical property of transmitting the second excitation light E2. The third optical layer 63 includes, for example, a dielectric multilayer film.

The fourth optical layer 64 is disposed between the light-transmissive member 79 and the first wavelength conversion element 51. The fourth optical layer 64 has an optical property of transmitting the yellow fluorescence Y and reflecting the first excitation light E1 and the blue fluorescence B. The fourth optical layer 64 of the embodiment has an optical property of reflecting the second excitation light E2, however, may have an optical property of transmitting the second excitation light E2. The fourth optical layer 64 includes, for example, a dielectric multilayer film.

The other configurations of the light source device 30G are the same as those of the light source device 30F of the sixth embodiment.

### Effects of Seventh Embodiment

In the embodiment, the same effects as those of the first embodiment can be obtained. That is, the yellow fluorescence Y and the blue fluorescence B propagate through the light guide portion 78, and thereby, the light source device 30G with the smaller loss of the yellow fluorescence Y and the blue fluorescence B and the higher use efficiency of the yellow fluorescence Y and the blue fluorescence B can be realized and the light source device 30G that can efficiently emit the white light LW can be realized.

Further, the same effects as those of the fifth embodiment can be obtained. That is, the yellow fluorescence Y and the blue fluorescence B are mainly emitted from the light guide portion 78, and thereby, the color unevenness in the optical system downstream of the light source device 30G can be suppressed. The respective wavelength conversion elements 51 and 52 can be efficiently cooled, and thereby, the higher wavelength conversion efficiency can be maintained.

In the embodiment, since the light guide portion 78 includes the light-transmissive member 79 like the sixth embodiment, the differences in refractive index between the respective wavelength conversion elements 51 and 52 and the light guide portion 78 are smaller and the critical angles at the interfaces between the respective wavelength conversion elements 51 and 52 and the light guide portion 78 are smaller than those of the fifth embodiment in which the light guide portion 76 includes the air layer 77. Furthermore, in the embodiment, for example, the yellow fluorescence Y3 traveling from the first wavelength conversion element 51 toward the second wavelength conversion element 52 is reflected by the third optical layer 63, and is not entered into or absorbed by the second wavelength conversion element 52. In addition, the blue fluorescence B4 traveling from the second wavelength conversion element 52 toward the first wavelength conversion element 51 is reflected by the fourth optical layer 64, and is not entered into the first wavelength conversion element 51 or converted into yellow fluorescence Y. Thereby, both the absorption of the yellow fluorescence Y entering the second wavelength conversion element 52 and the absorption of the blue fluorescence B entering the first wavelength conversion element 51 are suppressed, and the wavelength conversion efficiency can be increased as compared with the sixth embodiment.

### Eighth Embodiment

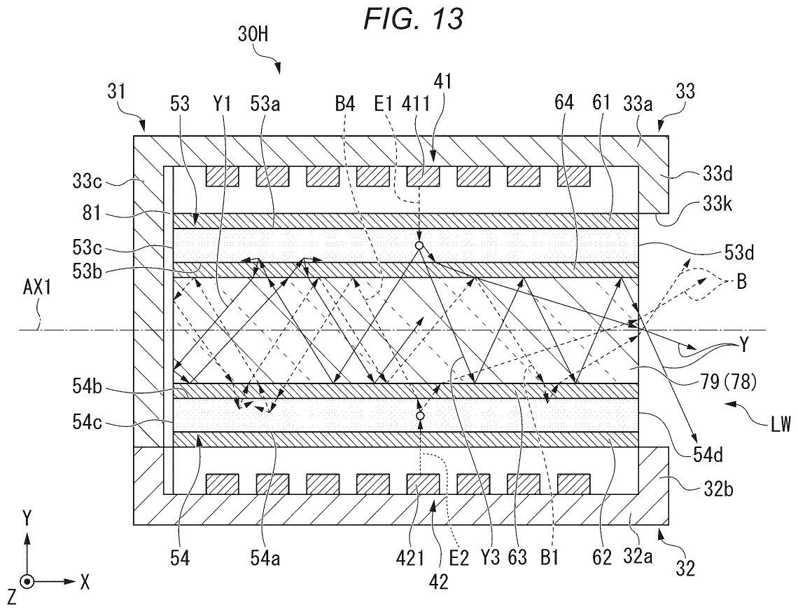

As below, an eighth embodiment of the present disclosure will be described using FIG. 13.

Since the basic configuration of the light source device of the eighth embodiment is the same as that of the seventh embodiment, the description of the basic configuration of the light source device is omitted.

FIG. 13 is a cross-sectional view of a light source device 30H of the eighth embodiment cut along the XY-plane. In FIG. 13, the component elements common to those in FIG. 12 used in the seventh embodiment have the same signs and the description thereof is omitted.

As shown in FIG. 13, the light source device 30H of the embodiment includes a housing 31, a first light source 41, a first wavelength conversion element 53, a first optical layer 61, a second light source 42, a second wavelength conversion element 54, a second optical layer 62, a light guide portion 78, a third optical layer 63, a fourth optical layer 64, a first reflection member 81, a third reflection member (not shown), and a fourth reflection member (not shown).

In the light source device 30G of the seventh embodiment, the first wavelength conversion element 51 and the second wavelength conversion element 52 are formed using the transparent phosphor. On the other hand, in the light source device 30H of the embodiment, the first wavelength conversion element 53 and the second wavelength conversion element are formed using phosphor having a light scattering property. The phosphor having the light scattering property can be realized by dispersion of a medium having a different refractive index from the transparent phosphor, for example, a scatterer such as pores or fillers in the transparent phosphor. The first wavelength conversion element 53 has a front surface 53a, a back surface 53b, a first end surface 53c, and a second end surface 53d. The second wavelength conversion element 54 has a front surface 54a, a back surface 54b, a first end surface 54c, and a second end surface 54d.

The other configurations of the light source device 30H are the same as those of the light source device 30G of the seventh embodiment.

### Effects of Eighth Embodiment

In the embodiment, the same effects as those of the first embodiment can be obtained. That is, the yellow fluorescence Y and the blue fluorescence B propagate through the light guide portion 78, and thereby, the light source device 30H with the smaller loss of the yellow fluorescence Y and the blue fluorescence B and the higher use efficiency of the yellow fluorescence Y and the blue fluorescence B can be realized and the light source device 30H that can efficiently emit the white light LW can be realized.

Further, the same effects as those of the fifth embodiment can be obtained. That is, the yellow fluorescence Y and the blue fluorescence B are mainly emitted from the light guide portion 78, and thereby, the color unevenness in the optical system downstream of the light source device 30H can be suppressed. The respective wavelength conversion elements 51 and 52 can be efficiently cooled, and thereby, the higher wavelength conversion efficiency can be maintained.

Furthermore, in the embodiment, since the first wavelength conversion element 53 and the second wavelength conversion element 54 are formed using the phosphor having the light scattering property, the following effects can be obtained.

In the seventh embodiment shown in FIG. 12, since the respective wavelength conversion elements 51 and 52 are formed using the transparent phosphor, scattering does not occur when the respective fluorescence Y and B propagates inside the respective wavelength conversion elements 51 and 52, and the traveling directions of the respective fluorescence Y and B are not changed. Accordingly, the yellow fluorescence Y emitted from the first wavelength conversion element 51 and re-entering the first wavelength conversion element 51 is reflected by the first optical layer 61, and then, re-emitted from the first wavelength conversion element 51. Therefore, part of the yellow fluorescence Y is absorbed by the phosphor while propagating inside the first wavelength conversion element 51 and results in a loss.

On the other hand, in the embodiment, since the first wavelength conversion element 53 is formed using the phosphor having the light scattering property, when the yellow fluorescence Y enters the first wavelength conversion element 53, a lot of scattering occurs and the traveling direction of the yellow fluorescence Y is changed at each time of scattering. Accordingly, as shown in FIG. 13, for example, the yellow fluorescence Y1 transmitted through the fourth optical layer 64 and entering the first wavelength conversion element 53 is scattered by the first wavelength conversion element 53 and changed in angle and emitted to the light-transmissive member 79, propagates inside the light-transmissive member 79, and then, is emitted from the region of the light-transmissive member 79 at the second end surface 53d side.

The blue fluorescence B exhibits the same behavior as the yellow fluorescence Y. For example, the blue fluorescence B1 transmitted through the third optical layer 63 and entering the second wavelength conversion element 54 is scattered by the second wavelength conversion element 54 and changed in angle and emitted to the light-transmissive member 79, propagates inside the light-transmissive member 79, and then, is emitted from the region of the light-transmissive member 79 at the second end surface 54d side. As described above, in the embodiment, the yellow fluorescence Y and the blue fluorescence B propagating inside the first wavelength conversion element 53 and the second wavelength conversion element 54 is almost absent.

As described above, in the embodiment, the yellow fluorescence Y propagates through the light guide portion 78 while being repeatedly scattered by the first wavelength conversion element 53 and reflected by the third optical layer 63, and is emitted from the region of the light guide portion 78 at the second end surface 53d side. The blue fluorescence B propagates through the light guide portion 78 while being repeatedly scattered by the second wavelength conversion element 54 and reflected by the fourth optical layer 64, and is emitted from the region of the light guide portion 78 at the second end surface 54d side. As a result, the loss of the respective fluorescence Y and B propagating through the first wavelength conversion element 53 and the second wavelength conversion element 54 is suppressed, and thus, the use efficiency of the respective fluorescence Y and B can be further increased as compared with the seventh embodiment. According to the light source device 30H of the embodiment, the highest wavelength conversion efficiency among all the embodiments can be obtained.

In the embodiment, the example in which the phosphor having the light scattering property is employed for the respective wavelength conversion elements 53 and 54 in the light source device 30G of the seventh embodiment is shown, however, the phosphor having the light scattering property may be employed for the respective wavelength conversion elements in the light source devices 30A to 30F of the other embodiments.

Note that the technical scope of the present disclosure is not limited to the above described embodiments, but various changes can be made without departing from the scope of the present disclosure.

As the constituent material of the first wavelength conversion element, for example, composite phosphor containing AlN and Ce:YAG may be used. According to the configuration, even when the contact area between the first wavelength conversion element and the housing is too small to secure a large number of heat dissipation paths, the thermal conductivity of the first wavelength conversion element can be increased as compared with a case where phosphor of only Ce:YAG is used. Thereby, the cooling efficiency of the first wavelength conversion element can be increased. Accordingly, the maximum amount of the first excitation light can be increased, and the maximum output of the yellow fluorescence can be increased. Similarly, composite phosphor may be used for the second wavelength conversion element.

In the above described embodiments, the first wavelength range is, for example, the violet-to-blue wavelength range from 400 nm to 480 nm, and the third wavelength range is, for example, the ultraviolet wavelength range having the center wavelength of 380 nm, however, the wavelength ranges are not limited thereto. The first wavelength range may be, for example, a blue wavelength range from 430 nm to 480 nm, and the third wavelength range may be a violet wavelength range having a center wavelength of, for example, 400 nm.

In addition, the specific description of the shapes, the numbers, the arrangements, the materials, and the like of the respective component elements of the light source device and the projector are not limited to those in the above described embodiments, but changes can be made as appropriate. Further, in the above described embodiments, the example in which the light source device according to the present disclosure is provided in the projector using the liquid crystal panels is shown, however, the application is not limited to that. The light source device according to the present disclosure may be applied to a projector using digital micromirror devices as the light modulation devices. Further, the projector does not necessarily have the plurality of light modulation devices, but may have a single light modulation device.

In the above described embodiments, the example in which the light source device according to the present disclosure is applied to the projector is shown, however, the application is not limited to that. The light source device according to the present disclosure may be applied to a lighting apparatus, a headlight of an automobile, or the like.

### Summary of Present Disclosure

The summary of the present disclosure is appended as below.

### Appendix 1

A light source device includes a first light source emitting a first light in a first wavelength range, a first wavelength conversion element converting the first light into a second light in a second wavelength range different from the first wavelength range, a first optical layer disposed between the first light source and the first wavelength conversion element and transmitting the first light and reflecting the second light, a first light guide portion disposed between the first optical layer and the first wavelength conversion element and guiding the second light converted by the first wavelength conversion element, a second light source emitting a third light in a third wavelength range, a second wavelength conversion element converting the third light into a fourth light in a fourth wavelength range different from the third wavelength range or the second wavelength range, a second optical layer disposed between the second light source and the second wavelength conversion element and transmitting the third light and reflecting the fourth light, a second light guide portion disposed between the second optical layer and the second wavelength conversion element and guiding the fourth light converted by the second wavelength conversion element, and a first reflection member reflecting the first light, the second light, the third light, and the fourth light, wherein the first wavelength conversion element includes a first surface entered by the first light via the first optical layer and the first light guide portion, and a second surface and a third surface crossing the first surface and facing opposite sides to each other, the second wavelength conversion element includes a fourth surface entered by the third light via the second optical layer and the second light guide portion, and a fifth surface and a sixth surface crossing the fourth surface and facing opposite sides to each other, the first reflection member is disposed in a region at the second surface side of the first light guide portion and a region at the fifth surface side of the second light guide portion, the second wavelength conversion element is disposed at a side opposite to the first light source with respect to the first wavelength conversion element, the second light converted by the first wavelength conversion element travels through the first light guide portion and is emitted from a region of the first light guide portion at the third surface side, and the fourth light converted by the second wavelength conversion element travels through the second light guide portion and is emitted from a region of the second light guide portion at the sixth surface side.

According to the configuration of Appendix 1, the second light propagates through the first light guide portion and the fourth light propagates through the second light guide portion, and thereby, the light source device with the smaller loss of the second light and the fourth light and the higher use efficiency of the second light and the fourth light can be realized. Further, the light source device that can efficiently emit a combined light formed by combination of the second light and the fourth light can be realized.

### Appendix 2

In the light source device according to Appendix 1, the first wavelength conversion element is joined to the second wavelength conversion element.

According to the configuration of Appendix 2, the first wavelength conversion element and the second wavelength conversion element can be handled as an integrated member, and thereby, the manufacturing process of the light source device can be made easier.

### Appendix 3

In the light source device according to Appendix 1, an air layer is disposed between the first wavelength conversion element and the second wavelength conversion element.

According to the configuration of Appendix 3, it is easier for the light converted by one wavelength conversion element to be totally reflected at the interface between the wavelength conversion element and the air layer and harder to enter the other wavelength conversion element. Therefore, absorption when the light converted by one wavelength conversion element enters the other wavelength conversion element is suppressed, and a decrease in wavelength conversion efficiency can be suppressed.

### Appendix 4

In the light source device according to Appendix 1, a second reflection member reflecting the first light, the second light, the third light, and the fourth light is disposed between the first wavelength conversion element and the second wavelength conversion element.

According to the configuration of Appendix 4, since the light converted by one wavelength conversion element is reflected by the second reflection member, the light does not enter the other wavelength conversion element. Thereby, absorption when the light converted by one wavelength conversion element enters the other wavelength conversion element is suppressed, and a decrease in wavelength conversion efficiency can be suppressed.

### Appendix 5

In the light source device according to Appendix 1, a scattering layer that reflects an incident light and changes an emission angle of the light is disposed between the first wavelength conversion element and the second wavelength conversion element.

According to the configuration of Appendix 5, since the light converted by one wavelength conversion element is reflected by the scattering layer and the emission angle is changed, entry of the light into the other wavelength conversion element can be suppressed. Thereby, absorption when the light converted by one wavelength conversion element enters the other wavelength conversion element is suppressed, and a decrease in wavelength conversion efficiency can be suppressed.

### Appendix 6

The light source device according to any one of Appendices 1 to 5, further includes a third reflection member and a fourth reflection member reflecting the first light, the second light, the third light, and the fourth light, wherein the first wavelength conversion element has a seventh surface and an eighth surface crossing the first surface, the second surface, and the third surface and facing opposite sides to each other, the second wavelength conversion element includes a ninth surface and a tenth surface crossing the fourth surface, the fifth surface, and the sixth surface and facing opposite sides to each other, the third reflection member is disposed in a region at the seventh surface side of the first light guide portion and a region at the ninth surface side of the second light guide portion, and the fourth reflection member is disposed in a region at the eighth surface side of the first light guide portion and a region at the tenth surface side of the second light guide portion.

According to the configuration of Appendix 6, the conversion efficiency from the first light to the second light and the conversion efficiency from the third light to the fourth light can be increased by the third reflection member and the fourth reflection member. Further, a loss of the second light and the fourth light from the seventh surface, the eighth surface, the ninth surface, and the tenth surface can be suppressed.

### Appendix 7

The light source device according to any one of Appendices 1 to 6, further includes a housing covering the first optical layer, the second optical layer, the first wavelength conversion element, and the second wavelength conversion element, wherein the housing has an extraction opening for extraction of the second light emitted from the region of the first light guide portion at the third surface side and the fourth light emitted from the region of the second light guide portion at the sixth surface side to the outside, and, in a plan view in a normal direction of the third surface of the first wavelength conversion element, the extraction opening overlaps with the first light guide portion, the first wavelength conversion element, the second light guide portion, and the second wavelength conversion element.

According to the configuration of Appendix 7, the first optical layer, the second optical layer, the first wavelength conversion element, and the second wavelength conversion element can be protected by the housing, and the second light propagating through the first light guide portion and the first wavelength conversion element and the fourth light propagating through the second light guide portion and the second wavelength conversion element can be extracted to the outside through the extraction opening of the housing.

### Appendix 8

In the light source device according to any one of Appendices 1 to 7, the first wavelength conversion element and the second wavelength conversion element are formed using transparent phosphor.

According to the configuration of Appendix 8, even when the first wavelength conversion element and the second wavelength conversion element formed using the transparent phosphor are used, the amount of the incident first light and third light is increased without upsizing of the respective wavelength conversion elements, and thereby, the second light and the fourth light can be efficiently extracted to the outside with the increased conversion efficiency of the second light and the fourth light.

### Appendix 9

In the light source device according to any one of Appendices 1 to 7, the first wavelength conversion element and the second wavelength conversion element are formed using phosphor having a light scattering property.

According to the configuration of Appendix 9, the second light generated inside the first wavelength conversion element is efficiently emitted to the first light guide portion and propagates through the first light guide portion, and thereby, a loss of the second light can be suppressed and extraction efficiency of the second light can be further increased. Further, the fourth light generated inside the second wavelength conversion element is efficiently emitted to the second light guide portion and propagates through the second light guide portion, and thereby, the extraction efficiency of the fourth light can be further increased.

### Appendix 10

In the light source device according to Appendix 9, the first wavelength conversion element contains yellow phosphor, the first light is a blue light, the second light is yellow fluorescence, the second wavelength conversion element contains blue phosphor, the third light is a ultraviolet light, the fourth light is blue fluorescence, the yellow fluorescence propagates through the first light guide portion while being repeatedly scattered by the first wavelength conversion element and reflected by the first optical layer, and is emitted from the region of the first light guide portion at the third surface side, and the blue fluorescence propagates through the second light guide portion while being repeatedly scattered by the second wavelength conversion element and reflected by the second optical layer, and is emitted from the region of the second light guide portion on the sixth surface side.

According to the configuration of Appendix 10, the yellow fluorescence generated inside the first wavelength conversion element can be efficiently extracted to the outside from the region of the first light guide portion at the third surface side. Further, the blue fluorescence generated inside the second wavelength conversion element can be efficiently extracted to the outside from the region of the second light guide portion at the sixth surface side.

### Appendix 11

A light source device includes a first light source emitting a first light in a first wavelength range, a first wavelength conversion element converting the first light into a second light in a second wavelength range different from the first wavelength range, a first optical layer disposed between the first light source and the first wavelength conversion element and transmitting the first light and reflecting the second light, a second light source emitting a third light in a third wavelength range, a second wavelength conversion element converting the third light into a fourth light in a fourth wavelength range different from the third wavelength range or the second wavelength range, a second optical layer disposed between the second light source and the second wavelength conversion element and transmitting the third light and reflecting the fourth light, a light guide portion disposed between the first wavelength conversion element and the second wavelength conversion element, and guiding the second light converted by the first wavelength conversion element and guiding the fourth light converted by the second wavelength conversion element, and a first reflection member reflecting the first light, the second light, the third light, and the fourth light, wherein the first wavelength conversion element includes a first surface entered by the first light via the first optical layer, and a second surface and a third surface crossing the first surface and facing opposite sides to each other, the second wavelength conversion element includes a fourth surface entered by the third light via the second optical layer, and a fifth surface and a sixth surface crossing the fourth surface and facing opposite sides to each other, the second wavelength conversion element is disposed at a side opposite to the first light source with respect to the first wavelength conversion element, the first reflection member is disposed in a region at the second surface side of the light guide portion, and the second light converted by the first wavelength conversion element and the fourth light converted by the second wavelength conversion element travel through the light guide portion and are emitted from a region of the light guide portion at the third surface side.

According to the configuration of Appendix 11, the second light and the fourth light propagate through the light guide portion, and thereby, the light source device with the smaller loss of the second light and the fourth light and the higher use efficiency of the second light and the fourth can be realized. Further, the light source device that can efficiently emit a combined light formed by combination of the second light and the fourth light can be realized.

### Appendix 12

In the light source device according to Appendix 11, the light guide portion is an air layer, and the second light converted by the first wavelength conversion element and the fourth light converted by the second wavelength conversion element travel through the air layer and are emitted from a region of the air layer at the third surface side.

According to the configuration of Appendix 12, as compared to a configuration in which the second light and the fourth light enter the light-transmissive member, the lights travel in a direction forming a smaller angle with respect to the longitudinal direction of the first wavelength conversion element and the second wavelength conversion element. As a result, when the second light reaches an interface between the air layer and another substance, it is easier for the light to be totally reflected and harder to leak to the outside. Thereby, the extraction efficiency of the second light and the fourth light can be increased.

### Appendix 13

The light source device according to Appendix 12, further includes a housing covering the first optical layer, the second optical layer, the first wavelength conversion element, and the second wavelength conversion element, wherein the housing has an extraction opening for extraction of the second light and the fourth light emitted from the region of the light guide portion at the third surface side to the outside, and, in a plan view in a normal direction of the third surface of the first wavelength conversion element, the extraction opening overlaps with the first wavelength conversion element, the light guide portion, and the second wavelength conversion element.

According to the configuration of Appendix 13, the first optical layer, the second optical layer, the first wavelength conversion element, and the second wavelength conversion element can be protected by the housing, and the second light propagating through the light guide portion and the first wavelength conversion element and the fourth light propagating through the light guide portion and the second wavelength conversion element can be extracted to the outside through the extraction opening of the housing.

### Appendix 14

In the light source device according to Appendix 11, a light-transmissive member that transmits the first light, the second light, the third light, and the fourth light is disposed in the light guide portion, and the second light converted by the first wavelength conversion element and the fourth light converted by the second wavelength conversion element travel inside the light-transmissive member and are emitted from an end surface of the light-transmissive member at the third surface side.

According to the configuration of Appendix 14, since the light-transmissive member is disposed in the light guide portion, the differences in refractive index between the respective wavelength conversion elements and the light guide portion are smaller and the critical angles at the interfaces between the respective wavelength conversion elements and the light guide portion are smaller than those of the configuration in which the light guide portion includes the air layer. Thereby, the second light and the fourth light generated in the respective wavelength conversion elements can be easily extracted to the light guide portion, and a loss due to reabsorption of the second light and the fourth light can be suppressed.

### Appendix 15

The light source device according to Appendix 14, further includes a third optical layer disposed between the light-transmissive member and the second wavelength conversion element, and transmitting the first light and the fourth light and reflecting the second light, and a fourth optical layer disposed between the light-transmissive member and the first wavelength conversion element, and transmitting the second light and reflecting the first light and the fourth light.

According to the configuration of Appendix 15, the second light traveling toward the second wavelength conversion element is reflected by the third optical layer, and is not entered into or absorbed by the second wavelength conversion element. Further, the first light and the fourth light traveling toward the first wavelength conversion element are reflected by the fourth optical layer, and is not entered into or absorbed by the first wavelength conversion element. Accordingly, both absorption of the second light entering the second wavelength conversion element and absorption of the fourth light entering the first wavelength conversion element are suppressed, and thereby, the wavelength conversion efficiency can be increased.

### Appendix 16

The light source device according to Appendix 14, further includes a housing covering the first optical layer, the second optical layer, the first wavelength conversion element, and the second wavelength conversion element, wherein the housing has an extraction opening for extraction of the second light and the fourth light emitted from the region of the light guide portion at the third surface side to the outside, and, in a plan view in a normal direction of the third surface of the first wavelength conversion element, the extraction opening overlaps with the first wavelength conversion element, the light-transmissive member, and the second wavelength conversion element.

According to the configuration of Appendix 16, the first optical layer, the second optical layer, the first wavelength conversion element, and the second wavelength conversion element can be protected by the housing, and the second light propagating through the light-transmissive member and the first wavelength conversion element and the fourth light propagating through the light-transmissive member and the second wavelength conversion element can be extracted to the outside through the extraction opening of the housing.

### Appendix 17

The light source device according to any one of Appendices 11 to 16, further includes a third reflection member and a fourth reflection member reflecting the first light, the second light, the third light, and the fourth light, wherein the first wavelength conversion element includes a seventh surface and an eighth surface crossing the first surface, the second surface, and the third surface and facing opposite sides to each other, the third reflection member is disposed in a region at the seventh surface side of the light guide portion, and the fourth reflection member is disposed in a region at the eighth surface side of the light guide portion.

According to the configuration of Appendix 17, the conversion efficiency from the first light to the second light and the conversion efficiency from the third light to the fourth light can be increased by the third reflection member and the fourth reflection member. Further, a loss of the second light and the fourth light from the seventh surface, the eighth surface, the ninth surface, and the tenth surface can be suppressed.

### Appendix 18

In the light source device according to any one of Appendices 11 to 17, the first wavelength conversion element and the second wavelength conversion element are formed using transparent phosphor.

According to the configuration of Appendix 18, even when the first wavelength conversion element and the second wavelength conversion element formed using the transparent phosphor are used, the amount of the incident first light and third light is increased without upsizing of the respective wavelength conversion elements, and thereby, the second light and the fourth light can be efficiently extracted to the outside with the increased conversion efficiency of the second light and the fourth light.

### Appendix 19

In the light source device according to any one of Appendices 11 to 17, the first wavelength conversion element and the second wavelength conversion element are formed using phosphor having a light scattering property.

According to the configuration of Appendix 19, the second light generated inside the first wavelength conversion element is efficiently emitted to the light guide portion and propagates through the light guide portion, and thereby, a loss of the second light can be suppressed and the extraction efficiency of the second light can be further increased. Further, the fourth light generated inside the second wavelength conversion element is efficiently emitted to the light guide portion and propagates through the light guide portion, and thereby, a loss of the fourth light can be suppressed and the extraction efficiency of the fourth light can be further increased.

### Appendix 20

In the light source device according to Appendix 19, the first wavelength conversion element contains yellow phosphor, the first light is a blue light, the second light is yellow fluorescence, the second wavelength conversion element contains blue phosphor, the third light is an ultraviolet light, the fourth light is blue fluorescence, the second optical layer reflects the second light, the yellow fluorescence propagates through the light guide portion while being repeatedly scattered by the first wavelength conversion element and reflected by the second optical layer, and is emitted from the region of the light guide portion at the third surface side, and the blue fluorescence propagates through the light guide portion while being repeatedly scattered by the second wavelength conversion element and scattered by the first wavelength conversion element, and is emitted from the region of the light guide portion at the third surface side.

According to the configuration of Appendix 20, the yellow fluorescence generated inside the first wavelength conversion element can be efficiently extracted to the outside from the region of the light guide portion at the third surface side. Further, the blue fluorescence generated inside the second wavelength conversion element can be efficiently extracted to the outside from the region of the light guide portion at the third surface side.

### Appendix 21

A projector includes the light source device according to any one of Appendices 1 to 10, a light modulation device modulating a light emitted from the light source device, and a projection optical device projecting the light modulated by the light modulation device.

According to the configuration of Appendix 21, since the light source device emits a combined light formed by combination of the second light and the fourth light, with only one light source device, the projector having the highly efficient and simple configuration can be realized.

### Appendix 22

A projector includes the light source device according to any one of Appendices 11 to 20, a light modulation device modulating a light emitted from the light source device, and a projection optical device projecting the light modulated by the light modulation device.

According to the configuration of Appendix 22, since the light source device emits a combined light formed by combination of the second light and the fourth light, with only one light source device, the projector having the highly efficient and simple configuration can be realized.

What is claimed is:

1. A light source device comprising:
a first light source emitting a first light in a first wavelength range;
a first wavelength conversion element converting the first light into a second light in a second wavelength range different from the first wavelength range;
a first optical layer disposed between the first light source and the first wavelength conversion element and transmitting the first light and reflecting the second light;
a first light guide portion disposed between the first optical layer and the first wavelength conversion element and guiding the second light converted by the first wavelength conversion element;
a second light source emitting a third light in a third wavelength range;
a second wavelength conversion element converting the third light into a fourth light in a fourth wavelength range different from the third wavelength range or the second wavelength range;
a second optical layer disposed between the second light source and the second wavelength conversion element and transmitting the third light and reflecting the fourth light;
a second light guide portion disposed between the second optical layer and the second wavelength conversion element and guiding the fourth light converted by the second wavelength conversion element; and
a first reflection member reflecting the first light, the second light, the third light, and the fourth light, wherein
the first wavelength conversion element includes a first surface entered by the first light via the first optical layer and the first light guide portion, and a second surface and a third surface crossing the first surface and facing opposite sides to each other,
the second wavelength conversion element includes a fourth surface entered by the third light via the second optical layer and the second light guide portion, and a fifth surface and a sixth surface crossing the fourth surface and facing opposite sides to each other,
the first reflection member is disposed in a region at the second surface side of the first light guide portion and a region at the fifth surface side of the second light guide portion,
the second wavelength conversion element is disposed at a side opposite to the first light source with respect to the first wavelength conversion element,
the second light converted by the first wavelength conversion element travels through the first light guide portion and is emitted from a region of the first light guide portion at the third surface side, and
the fourth light converted by the second wavelength conversion element travels through the second light guide portion and is emitted from a region of the second light guide portion at the sixth surface side.

2. The light source device according to claim 1, wherein
the first wavelength conversion element is joined to the second wavelength conversion element.

3. The light source device according to claim 1, wherein
an air layer is disposed between the first wavelength conversion element and the second wavelength conversion element.

4. The light source device according to claim 1, wherein
a second reflection member reflecting the first light, the second light, the third light, and the fourth light is disposed between the first wavelength conversion element and the second wavelength conversion element.

5. The light source device according to claim 1, wherein
a scattering layer that reflects an incident light and changes an emission angle of the light is disposed between the first wavelength conversion element and the second wavelength conversion element.

6. The light source device according to claim 1, further comprising a third reflection member and a fourth reflection member reflecting the first light, the second light, the third light, and the fourth light, wherein
the first wavelength conversion element has a seventh surface and an eighth surface crossing the first surface, the second surface, and the third surface and facing opposite sides to each other,
the second wavelength conversion element includes a ninth surface and a tenth surface crossing the fourth surface, the fifth surface, and the sixth surface and facing opposite sides to each other,
the third reflection member is disposed in a region at the seventh surface side of the first light guide portion and a region at the ninth surface side of the second light guide portion, and
the fourth reflection member is disposed in a region at the eighth surface side of the first light guide portion and a region at the tenth surface side of the second light guide portion.

7. The light source device according to claim 1, further comprising a housing covering the first optical layer, the second optical layer, the first wavelength conversion element, and the second wavelength conversion element, wherein
the housing has an extraction opening for extraction of the second light emitted from the region of the first light guide portion at the third surface side and the fourth light emitted from the region of the second light guide portion at the sixth surface side to the outside, and
in a plan view in a normal direction of the third surface of the first wavelength conversion element, the extraction opening overlaps with the first light guide portion, the first wavelength conversion element, the second light guide portion, and the second wavelength conversion element.

8. The light source device according to claim 1, wherein
the first wavelength conversion element and the second wavelength conversion element are formed using transparent phosphor.

9. The light source device according to claim 1, wherein
the first wavelength conversion element and the second wavelength conversion element are formed using phosphor having a light scattering property.

10. The light source device according to claim 9, wherein
the first wavelength conversion element contains yellow phosphor,
the first light is a blue light,
the second light is yellow fluorescence,
the second wavelength conversion element contains blue phosphor,
the third light is an ultraviolet light,
the fourth light is blue fluorescence,
the yellow fluorescence propagates through the first light guide portion while being repeatedly scattered by the first wavelength conversion element and reflected by the first optical layer, and is emitted from the region of the first light guide portion at the third surface side, and
the blue fluorescence propagates through the second light guide portion while being repeatedly scattered by the second wavelength conversion element and reflected by the second optical layer, and is emitted from the region of the second light guide portion at the sixth surface side.

11. A light source device comprising:
a first light source emitting a first light in a first wavelength range;
a first wavelength conversion element converting the first light into a second light in a second wavelength range different from the first wavelength range;
a first optical layer disposed between the first light source and the first wavelength conversion element and transmitting the first light and reflecting the second light;
a second light source emitting a third light in a third wavelength range;
a second wavelength conversion element converting the third light into a fourth light in a fourth wavelength range different from the third wavelength range or the second wavelength range;
a second optical layer disposed between the second light source and the second wavelength conversion element and transmitting the third light and reflecting the fourth light;
a light guide portion disposed between the first wavelength conversion element and the second wavelength conversion element, and guiding the second light converted by the first wavelength conversion element and guiding the fourth light converted by the second wavelength conversion element; and
a first reflection member reflecting the first light, the second light, the third light, and the fourth light, wherein
the first wavelength conversion element includes a first surface entered by the first light via the first optical layer, and a second surface and a third surface crossing the first surface and facing opposite sides to each other,
the second wavelength conversion element includes a fourth surface entered by the third light via the second optical layer, and a fifth surface and a sixth surface crossing the fourth surface and facing opposite sides to each other,
the second wavelength conversion element is disposed at a side opposite to the first light source with respect to the first wavelength conversion element,
the first reflection member is disposed in a region at the second surface side of the light guide portion, and
the second light converted by the first wavelength conversion element and the fourth light converted by the second wavelength conversion element travel through the light guide portion and are emitted from a region of the light guide portion at the third surface side.

12. The light source device according to claim 11, wherein
the light guide portion is an air layer, and
the second light converted by the first wavelength conversion element and the fourth light converted by the second wavelength conversion element travel through the air layer and are emitted from a region of the air layer at the third surface side.

13. The light source device according to claim 12, further comprising a housing covering the first optical layer, the second optical layer, the first wavelength conversion element, and the second wavelength conversion element, wherein
the housing has an extraction opening for extraction of the second light and the fourth light emitted from the region of the light guide portion at the third surface side to the outside, and
in a plan view in a normal direction of the third surface of the first wavelength conversion element, the extraction opening overlaps with the first wavelength conversion element, the light guide portion, and the second wavelength conversion element.

14. The light source device according to claim 11, wherein
a light-transmissive member that transmits the first light, the second light, the third light, and the fourth light is disposed in the light guide portion, and
the second light converted by the first wavelength conversion element and the fourth light converted by the second wavelength conversion element travel inside the light-transmissive member and are emitted from an end surface of the light-transmissive member at the third surface side.

15. The light source device according to claim 14, further comprising:
a third optical layer disposed between the light-transmissive member and the second wavelength conversion element, and transmitting the first light and the fourth light and reflecting the second light; and
a fourth optical layer disposed between the light-transmissive member and the first wavelength conversion element, and transmitting the second light and reflecting the first light and the fourth light.

16. The light source device according to claim 14, further comprising a housing covering the first optical layer, the second optical layer, the first wavelength conversion element, and the second wavelength conversion element, wherein
the housing has an extraction opening for extraction of the second light and the fourth light emitted from the region of the light guide portion at the third surface side to the outside, and
in a plan view in a normal direction of the third surface of the first wavelength conversion element, the extraction opening overlaps with the first wavelength conversion element, the light-transmissive member, and the second wavelength conversion element.

17. The light source device according to claim 11, further comprising a third reflection member and a fourth reflection member reflecting the first light, the second light, the third light, and the fourth light, wherein
the first wavelength conversion element includes a seventh surface and an eighth surface crossing the first surface, the second surface, and the third surface and facing opposite sides to each other,
the third reflection member is disposed in a region at the seventh surface side of the light guide portion, and
the fourth reflection member is disposed in a region at the eighth surface side of the light guide portion.

18. The light source device according to claim 11, wherein
the first wavelength conversion element and the second wavelength conversion element are formed using transparent phosphor.

19. The light source device according to claim 11, wherein
the first wavelength conversion element and the second wavelength conversion element are formed using phosphor having a light scattering property.

20. The light source device according to claim 19, wherein
the first wavelength conversion element contains yellow phosphor,
the first light is a blue light,
the second light is yellow fluorescence,
the second wavelength conversion element contains blue phosphor,
the third light is an ultraviolet light,
the fourth light is blue fluorescence,
the second optical layer reflects the second light,
the yellow fluorescence propagates through the light guide portion while being repeatedly scattered by the first wavelength conversion element and reflected by the second optical layer, and is emitted from the region of the light guide portion at the third surface side, and
the blue fluorescence propagates through the light guide portion while being repeatedly scattered by the second wavelength conversion element and scattered by the first wavelength conversion element, and is emitted from the region of the light guide portion at the third surface side.

21. A projector comprising:
the light source device according to claim 1;
a light modulation device modulating a light emitted from the light source device; and
a projection optical device projecting the light modulated by the light modulation device.

22. A projector comprising:
the light source device according to claim 11;
a light modulation device modulating a light emitted from the light source device; and
a projection optical device projecting the light modulated by the light modulation device.
